(19) United States
(12) Patent Application Publication
(10) Pub. No.: US 2018/0376499 A1
(43) Pub. Date: Dec. 27, 2018

(54) METHOD AND USER EQUIPMENT FOR TRANSMITTING PHYSICAL UPLINK SHARED CHANNELS

(71) Applicant: Samsung Electronics Co., Ltd., Gyeonggi-do (KR)

(72) Inventors: Jingxing FU, Beijing (CN); Yingyang LI, Beijing (CN); Shichang ZHANG, Beijing (CN); Yi WANG, Beijing (CN)

(73) Assignee: Samsung Electronics Co., Ltd., Gyeonggi-do (KR)

(21) Appl. No.: 15/773,645

(22) PCT Filed: Nov. 7, 2016
(86) PCT No.: PCT/KR2016/012739

§ 371 Date: May 4, 2018

(30) Foreign Application Priority Data
Nov. 6, 2015 (CN) 201510752760.2

(51) Int. Cl. H04W 72/14; H04L 1/18; H04W 72/12

(52) U.S. Cl. CPC H04W 72/14; H04W 88/02; H04W 72/1284; H04L 1/1812

(57) ABSTRACT

The present disclosure provides a method for transmitting physical uplink shared channels (PUSCHs), including: receiving, by a user equipment (UE), configuration information from a base station, in which configuration information is to configure an operation mode of the UE to operate on shortened subframes; determining, by the UE, a timing relationship from uplink grant (UL Grant) to PUSCH, a timing relationship from physical hybrid automatic retransmission request (ARQ) indicator channel (PHICH) to PUSCH, and a timing relationship from PUSCH to PHICH, and detecting a UL grant and/or a PHICH according to the determined timing relationship; in which the timing relationships are used for transmission of PUSCHs on shortened subframes; and transmitting, by the UE, based on the detected UL Grant and/or the PHICH, data of a PUSCH of a shortened uplink subframe according to the timing relationships determined by the UE in block 302.

### TECHNICAL FIELD

The present disclosure relates to mobile communication technologies, and particularly to a method for transmitting physical uplink shared channels (PUSCHs) on shortened uplink subframes.

### BACKGROUND ART

A long term evolution (LTE) technique supports two types of duplexing: frequency division duplexing (FDD) and time division duplexing (TDD). FIG. 1 is a schematic diagram of a frame structure of a LTE TDD system. In FIG. 1, each radio frame is 10 ms long, and is equally divided into two half frames having a length of 5 ms each. Each half frame includes 8 time slots having a length of 0.5 ms each and 3 special fields having an overall length of 1 ms. The 3 special fields are respectively a downlink pilot time slot (DwPTS), a guard period (GP), and an uplink pilot time slot (UpPTS). Each subframe consists of two consecutive time slots.

Transmissions in a TDD system include a transmission from a base station to a user equipment (UE) (referred to as an uplink transmission) and a transmission from the UE to the base station (referred to as a downlink transmission). Based on the frame structure shown in FIG. 1, downlink transmissions and uplink transmissions share 10 subframes in every 10 ms, and each subframe is configured either for an uplink transmission or for a downlink transmission. A subframe configured for an uplink transmission is called an uplink subframe, and a subframe configured for a downlink transmission is called a downlink subframe. The TDD system supports 7 TDD uplink and downlink configurations, as shown in Table 1a, where “D” represents a downlink subframe, “U” represents an uplink subframe, and “S” represents a special subframe containing the 3 special fields.

TABLE 1a
TDD uplink/downlink configurations

| Config- | Switch-point | | Subframe Number | | | | | | | | | |
|---|---|---|---|---|---|---|---|---|---|---|---|---|
| uration | Periodicity | | 0 | 1 | 2 | 3 | 4 | 5 | 6 | 7 | 8 | 9 |
| 0 | 5 | ms | D | S | U | U | U | D | S | U | U | U |
| 1 | 5 | ms | D | S | U | U | D | D | S | U | U | D |
| 2 | 5 | ms | D | S | U | D | D | D | S | U | D | D |
| 3 | 10 | ms | D | S | U | U | U | D | D | D | D | D |
| 4 | 10 | ms | D | S | U | U | D | D | D | D | D | D |
| 5 | 10 | ms | D | S | U | D | D | D | D | D | D | D |
| 6 | 10 | ms | D | S | U | U | U | D | S | U | U | D |

The LTE TDD system supports a synchronous hybrid automatic retransmission request (HARQ) mechanism, a basic principle of which is that a base station allocates uplink resources for a UE; the UE uses the uplink resources allocated to transmit uplink data to the base station; the base station receives the uplink data and transmits HARQ indicator information to the UE, and the UE retransmits the uplink data according to HARQ indicator information. To be specific, the UE bears the uplink data through a PUSCH, the base station bears scheduling and controling information of the PUSCH, i.e., an uplink grant (UL Grant), through a physical downlink control channel (PDCCH), and the base station bears HARQ indicator information through a physical hybrid ARQ indicator channel (PHICH). In the foregoing procedure, a timing position of a transmission of a PUSCH and a timing position of a subsequent retransmission thereof are determined based on a preconfigured timing relationship which includes a timing relationship from UL Grant to PUSCH, a timing relationship from PHICH to PUSCH, and a timing relationship from PUSCH to PHICH. In the following, the three timing relationships are called PUSCH synchronous HARQ timing relationships.

First, the timing relationship from UL Grant or PHICH to PUSCH in the LTE and LTE-A systems is introduced.

For the timing relationship from UL Grant to PUSCH, assuming that the UE receives a UL Grant on a downlink subframe n (n is a subframe number, same applying in the following), then the UL Grant is used to schedule a PUSCH on an uplink subframe n+k. Here, values of k are specified in Table 1b. To be specific, for the TDD uplink and downlink configurations (or abbreviated as uplink and downlink configurations) 1-6, since the number of uplink subframes is smaller than or equal to the number of downlink subframes (a frame S can be used as a downlink subframe), for any downlink subframe n, by a unique value of k, a unique PUSCH synchronous HARQ timing relationship can be configured, which when reflected in the Table 1b, is that a downlink subframe may not schedule a PUSCH, or only schedule a PUSCH within an uplink subframe; but for the TDD uplink and downlink configuration 0, since the number of uplink subframes is larger than the number of downlink subframes, and a PDCCH of each downlink subframe needs to schedule PUSCHs on two uplink subframes, thus, the value of k is not unique, an uplink index (UL index) technique needs to be used for a PDCCH to support scheduling PUSCHs on two uplink subframes, and for PUSCHs having different indices, k have different values. For example, when the UE receives a PDCCH on a downlink subframe 0, the PDCCH on the downlink subframe 0 schedules a PUSCH(s) on an uplink subframe 4 and/or an uplink subframe 7; and when the UE receives a PDCCH on a downlink subframe 1, the PDCCH on the downlink subframe 1 schedules a PUSCH(s) on an uplink subframe 7 and/or an uplink subframe 8.

For the timing relationship from PHICH to PUSCH, in the LTE and LTE-A, a PUSCH in each uplink subframe is allocated with a PHICH resource set independently. Assume that the UE receives a PHICH on a downlink subframe n, then the PHICH is configured to control a PUSCH on an uplink subframe n+j. Here, values of j are specified in Table 1b. To be specific, for the TDD uplink and downlink configurations 1-6, since the number of uplink subframes is smaller than or equal to the number of downlink subframes, for any downlink subframe n, through a unique value of j, a unique PUSCH synchronous HARQ timing relationship can be configured, which when reflected in the Table 1b, is that a downlink subframe may not be configured with a PHICH resource set, or may be only configured with a PHICH resource set of one uplink subframe; and for the TDD uplink and downlink configuration 0, since the number of uplink subframes is larger than the number of downlink subframes, then values of j are not unique, but the downlink subframes 0 and 5 are configured with two PHICH resource sets, i.e., a PHICH resource 0 and a PHICH resource 1, and for different PHICH resources, different values of j are used. For example, when the UE receives a PHICH on the downlink subframe 0, a PUSCH(s) on an uplink subframe 4 and/or an uplink subframe 7 will be triggered.

TABLE 1b
Timing relationship from UL Grant/PHICH to PUSCH

| | subframe number | | | | | | | | | |
|---|---|---|---|---|---|---|---|---|---|---|
| Configuration | 0 | 1 | 2 | 3 | 4 | 5 | 6 | 7 | 8 | 9 |
| 0 | 4, 7 | 6, 7 | | | | 4, 7 | 6, 7 | | | |
| 1 | | 6 | | | 4 | | 6 | | | 4 |
| 2 | | | | 4 | | | | | 4 | |
| 3 | 4 | | | | | | | | 4 | 4 |
| 4 | | | | | | | | | 4 | 4 |
| 5 | | | | | | | | | 4 | |
| 6 | 7 | 7 | | | | 7 | 7 | | | 5 |

Then, the timing relationship from PUSCH to PHICH in the LTE and LTE-A is introduced.

For the TDD uplink and downlink configurations 1-6, when the UE receives a PHICH on a downlink subframe n, the PHICH indicates HARQ-ACK information of a PUSCH within an uplink subframe n-h, where values of h are shown in Table 1c.

For the TDD uplink and downlink configuration 0, since two PHICH resources are configured, then when the UE receives a PHICH from a PHICH resource on a downlink subframe n, the PHICH indicates HARQ-ACK information of a PUSCH within an uplink subframe n-h; when the UE receives a PHICH from a PHICH resource on a downlink subframe 0 or downlink subframe 5, then the PHICH indicates HARQ-ACK information of a PUSCH on an uplink subframe n−6.

TABLE 1c
Mapping Relationship from PUSCH to PHICH

| | Subframe number | | | | | | | | | |
|---|---|---|---|---|---|---|---|---|---|---|
| Configuration | 0 | 1 | 2 | 3 | 4 | 5 | 6 | 7 | 8 | 9 |
| 0 | 7 | 4 | | | | 7 | 4 | | | |
| 1 | | 4 | | | 6 | | 4 | | | 6 |
| 2 | | | | 6 | | | | | 6 | |
| 3 | 6 | | | | | | | | 6 | 6 |
| 4 | | | | | | | | | 6 | 6 |
| 5 | | | | | | | | | 6 | |
| 6 | 6 | 4 | | | | 7 | 4 | | | 6 |

According to the foregoing tables (Table 1b and Table 1c) of the three timing relationships, a PUSCH synchronous HARQ timing relationship used when a cell adopts a specific TDD uplink and downlink configuration can be determined, so as to realize synchronous transmission of PUSCHs based on the PUSCH synchronous HARQ timing relationship.

With higher requirements for data latency by users, since some services are sensible for latency, people raise a concept of shortened transmission time interval (TTI) (abbreviated as shortened subframe hereinafter) which is to shorten latency of data transmission by shortening the length of data transmission blocks to improve user experience. For example, a current subframe of 1 ms is changed to 2 subframes of 0.5 ms each. As shown in FIG. 2, the first time slot is for a shortened subframe, and the second time slot is a shortened subframe too. The sizes of the shortened subframes are same. That is to say, the length of a shortened subframe is smaller than the length of a subframe (i.e., 1 ms).

### DISCLOSURE OF INVENTION

### Technical Problem

At present, if a UE is configured with a carrier aggregation system, according to a current protocol, the UE can configure whether to simultaneously transmit a PUSCH and a PUCCH on a same subframe according to higher layer signaling (simultaneous PUCCH-PUSCH-r10, see 3GPP TS 36.331 V10.2.0 protocol). If a parameter of higher layer signaling is true, when a PUCCH and a PUSCH are present on a same subframe, the UE can transmit the PUCCH and the PUSCH on the same subframe; and if the parameter is false, when a PUCCH and a PUSCH are present on a same subframe, the UE only transmits the PUSCH but does not transmit the PUCCH, and information that needs to be transmitted by the PUCCH is transmitted in the PUSCH.

### Solution to Problem

A method for transmitting physical uplink shared channels (PUSCHs), comprising:

receiving, by a user equipment (UE), configuration information from a base station, wherein the configuration information is to configure an operation mode of the UE to operate on shortened subframes;

determining, by the UE, a timing relationship from uplink grant (UL Grant) to PUSCH, a timing relationship from physical hybrid automatic retransmission request (ARQ) indicator channel (PHICH) to PUSCH, and a timing relationship from PUSCH to PHICH, and detecting a UL grant and/or a PHICH according to the determined timing relationships; wherein the timing relationships are used for transmission of PUSCHs on shortened subframes; and

transmitting, by the UE, based on the detected UL Grant and/or the PHICH, data of a PUSCH of a shortened uplink subframe according to the timing relationships determined by the UE.

Preferably, wherein latency from the UL Grant/PHICH to the PUSCH is not smaller than preset s1 milliseconds, and latency from the PUSCH to a PHICH is not smaller than preset s2 milliseconds.

Preferably, wherein s1=2, or s2=2.

Preferably, wherein the timing relationship from UL Grant/PHICH to PUSCH is that the UL Grant/PHICH received on a shortened downlink subframe n is used to schedule the PUSCH on an uplink subframe n+k, where values of k are shown in Table 1, and “/” indicates “or”,

TABLE 1

| | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| Configuraton | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | |
|---|---|---|---|---|---|---|---|---|---|
| 0 | 4 | 4 | 4 | 4 | 4 | 4 | 4 | 4 | |
| 1 | 4 | 4 | 4 | 4 | 4 | 4 | 4 | 4 | |
| 2 | 4 | 4 | | | 4 | 4 | | | |
| 3 | 4 | 4 | 4 | 4 | | | | | |
| 4 | 4 | 4 | 4 | 4 | | | | | |
| 5 | 4 | 4 | | | | | | | |
| 6 | 4 | 4 | 4 | 4 | 4 | 4 | 4 | 4 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 2,

TABLE 2

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 6 | 6 | 6 | 6 | 6 | 6 | 6 | 6 |
| 1 | 6 | 6 | 6 | 6 | 6 | 6 | 6 | 6 |
| 2 | 6 | 6 | | | 6 | 6 | | |
| 3 | 16 | 16 | 16 | 16 | | | | |
| 4 | 16 | 16 | 16 | 16 | | | | |
| 5 | 16 | 16 | | | | | | |
| 6 | 6 | 6 | 6 | 6 | 6 | 6 | 6 | 6 |

Preferably, wherein the timing relationship from UL Grant/PHICH to PUSCH is that the UL Grant/PHICH received on a shortened downlink subframe n is used to schedule the PUSCH on a shortened uplink subframe n+k, where values of k are shown in Table 3,

TABLE 3

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 0 | 4 | 4 | 4, 5 | 4 | 4 | 4, 5 |
| 1 | 4 | 4 | 4, 5 | 4 | 4 | 4, 5 |
| 2 | 4 | 4 | | 4 | 4 | |
| 3 | 4 | 4 | 4, 5 | | | |
| 4 | 4 | 4 | 4, 5 | | | |
| 5 | 4 | 4 | | | | |
| 6 | 4 | 4 | 4, 5 | 4 | 4 | 4, 5 |

the timing relationship from PUSCH to PHICH is that the PHICH corresponding to the PUSCH transmitted on a shortened uplink subframe n is transmitted on a shortened downlink subframe n+k′, where values of k′ are shown in Table 4,

TABLE 4

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | |
|---|---|---|---|---|---|---|---|---|---|
| 0 | 6 | 6 | 6 | 5 | 6 | 6 | 6 | 5 | |
| 1 | 6 | 6 | 6 | 5 | 6 | 6 | 6 | 5 | |
| 2 | 6 | 6 | | | 6 | 6 | | | |
| 3 | 16 | 16 | 16 | 15 | | | | | |
| 4 | 16 | 16 | 16 | 15 | | | | | |
| 5 | 16 | 16 | | | | | | | |
| 6 | 6 | 6 | 6 | 5 | 6 | 6 | 6 | 5 | ; |

and

for shortened downlink subframes 0, 1, 10 and 11 in TDD uplink and downlink configurations 0, 1, 2, and 6 and shortened downlink subframes 0 and 1 in TDD uplink and downlink configurations 3, 4, and 5, only one PHICH source set is configured; and for shortened downlink subframes 2 and 12 in the TDD uplink and downlink configurations 0, 1, and 6 and shortened downlink subframe 2 in the TDD uplink and downlink configurations 3 and 4, two PHICH resource sets are configured.

Preferably, The method of claim 1, 2, or 3, wherein the timing relationship from UL Grant/PHICH to PUSCH is that the UL Grant/PHICH received on a shortened downlink subframe n is configured to schedule the PUSCH on a shortened uplink subframe n+k, where values of k are shown in Table 5,

TABLE 5

| | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | | | |
|---|---|---|---|---|---|---|---|---|---|---|---|---|
| 0 | 4 | 4 | 4 | 4 | | | 4 | 4 | 4 | 4 | | |
| 1 | 6 | 6 | | | 6 | 6 | 6 | 6 | | | 6 | 6 |
| 2 | 4 | 4 | | | | | 4 | 4 | | | | |
| 3 | 6 | 6 | | | | | | | | | 6 | 6 |
| 4 | 6 | 6 | | | | | | | | | 6 | 6 |
| 5 | 4 | 4 | | | | | | | | | | |
| 6 | 4 | 4 | 4 | 4 | | | 4 | 4 | 4 | 4 | | ; |

the timing relation from PUSCH to PHICH is that the PHICH corresponding to the PUSCH transmitted on a shortened uplink subframe n is transmitted on a shortened downlink subframe n+k′, where values of k′ are shown in Table 6,

TABLE 6

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | |
|---|---|---|---|---|---|---|---|---|---|
| 0 | 6 | 6 | 6 | 6 | 6 | 6 | 6 | 6 | |
| 1 | 6 | 6 | 6 | 6 | 6 | 6 | 6 | 6 | |
| 2 | 6 | 6 | | | 6 | 6 | | | |
| 3 | 6 | 6 | 6 | 6 | 6 | 6 | 6 | 6 | |
| 4 | 16 | 16 | 16 | 16 | | | | | |
| 5 | 16 | 16 | | | | | | | |
| 6 | 6 | 6 | 6 | 6 | 6 | 6 | 6 | 6 | . |

Preferably, wherein the timing relationship from UL Grant/PHICH to PUSCH is that the UL Grant/PHICH received on a shortened downlink subframe n is used to schedule the PUSCH on a shortened uplink subframe n+k, where values of k are shown in Table 7,

TABLE 7

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | |
|---|---|---|---|---|---|---|---|---|---|---|
| 0 | 4 | 4 | 4, 5 | | | 4 | 4 | 4, 5 | | |
| 1 | 6 | 6 | | 6 | 6 | 6 | 6 | | 6 | 6 |
| 2 | 4 | 4 | | | | 4 | 4 | | | |
| 3 | 6 | 6 | | | | | | | 6 | 6 |
| 4 | 6 | 6 | | | | | | | 6 | 6 |
| 5 | 4 | 4 | | | | | | | | |
| 6 | 4 | 4 | 4, 5 | | | 4 | 4 | 4, 5 | | ; |

and

the timing relationship from PUSCH to PHICH is that the PHICH corresponding to the PUSCH transmitted on a shortened uplink subframe n is transmitted on a shortened downlink subframe n+k′, where values of k′ are as shown in Table 8,

TABLE 8

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 6 | 6 | 6 | 5 | 6 | 6 | 6 | 5 |
| 1 | 4 | 4 | 4 | 4 | 4 | 4 | 4 | 4 |
| 2 | 6 | 6 | | | 6 | 6 | | |
| 3 | 14 | 14 | 14 | 14 | | | | |
| 4 | 14 | 14 | 14 | 14 | | | | |
| 5 | 16 | 16 | | | | | | |
| 6 | 6 | 6 | 6 | 5 | 6 | 6 | 6 | 5 |

for shortened downlink subframes 2 and 12 in TDD uplink and downlink configurations 0 and 6, two PHICH resource sets are configured, and for shortened downlink subframes 0, 1, 10, and 11 in the TDD uplink and downlink configurations 0 and 6 and shortened downlink subframes on other TDD uplink and downlink configurations, one PHICH resource set is configured.

Preferably, wherein for the TDD uplink and downlink configuration 0, the timing relationship from UL Grant/PHICH to PUSCH is that the UL Grant/PHICH received on a shortened downlink subframe n is configured to schedule the PUSCH on a shortened uplink subframe n+k, where values of k are shown in Table 9,

TABLE 9

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | |
|---|---|---|---|---|---|---|---|---|---|
| 0 | 4, 5 | 5, 6 | 6 | 6 | 4, 5 | 5, 6 | 6 | 6 | ; |

the timing relationship from PUSCH to PHICH is that the PHICH corresponding to the PUSCH transmitted on a shortened downlink subframe n is transmitted on a shortened downlink subframe n+k′, where values of k′ are shown in Table 10,

TABLE 10

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | | | |
|---|---|---|---|---|---|---|---|---|---|---|---|---|
| 0 | 6 | 5 | 5 | 4 | 4 | 4 | 6 | 5 | 5 | 4 | 4 | 4; |

shortened downlink subframes 0, 1, 10, and 11 in a TDD uplink downlink configuration 0 is configured with two PHICH resource sets, and shortened downlink subframes 2, 3, 12, and 13 in the TDD uplink and downlink configuration 0 are configured with one PHICH resource set; and/or,

for a TDD uplink and downlink configuration 6, the timing relationship from UL Grant/PHICH to PUSCH is that the UL Grant/PHICH received on a shortened downlink subframe n is configured to schedule the PUSCH on a shortened uplink subframe n+k, where values of k are shown in Table 11,

TABLE 11

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 6 | 4, 5 | 5, 6 | 6 | 6 | 4 | 4 | 4 | 4 |

the timing relationship from PUSCH to PHICH is that the PHICH corresponding to the PUSCH transmitted on a shortened uplink subframe n is transmitted on a shortened downlink subframe n+k′, where values of k′ are shown in Table 12,

TABLE 12

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | | |
|---|---|---|---|---|---|---|---|---|---|---|---|
| 6 | 6 | 5 | 5 | 4 | 4 | 4 | 6 | 6 | 6 | 6 | , |

shortened downlink subframes 0, 1, 2, 3, 12, and 13 in the TDD uplink and downlink configuration 6 are configured with one PHICH resource set, and shortened downlink subframes 10 and 11 in the TDD uplink and downlink configuration 6 are configured with two PHICH resource sets; or for the TDD uplink and downlink configuration 6, the timing relationship from UL Grant/PHICH to PUSCH is that the UL Grant/PHICH received on a shortened downlink subframe n is used to schedule the PUSCH on a shortened unlink subframe n+k, where values of k are shown in Table 13,

TABLE 13

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 6 | 4, 5 | 5, 6 | 6 | 6 | 4 | 4 | 4, 5 | , |

the timing relationship from PUSCH to PHICH is that: the PHICH corresponding to the PUSCH transmitted on a shortened uplink subframe n is transmitted on a shortened downlink subframe n+k′, where values of k′ are shown in Table 14,

TABLE 14

| | Shortened uplink subframe n for PUSCH transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | | |
|---|---|---|---|---|---|---|---|---|---|---|---|
| 6 | 6 | 5 | 5 | 4 | 4 | 4 | 6 | 6 | 6 | 5 | , |

the shortened downlink subframe 0, 1, 12, and 13 in TDD uplink and downlink configuration 6 are configured with one PHICH resource set, and the shortened downlink subframes 2, 10 and 11 in the TDD uplink and downlink configuration 6 are configured with two PHICH resource sets; and/or

for TDD uplink and downlink configuration 3, the timing relationship from UL Grant/PHICH to PUSCH is that the UL Grant/PHICH received on a shortened downlink subframe n is used to schedule the PUSCH on the shortened uplink subframe n+k, where values of k are shown in Table 15,

TABLE 15

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | |
|---|---|---|---|---|---|
| 3 | 4, 5 | 5, 6 | 6 | 6 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 16,

TABLE 16

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | |
|---|---|---|---|---|---|---|---|
| 3 | 16 | 15 | 15 | 14 | 14 | 14 | ; |

the shortened downlink subframes 0 and 1 in the TDD uplink and downlink configuration 3 are configured with two PHICH resources sets, and shortened downlink subframes 2 and 3 in the TDD uplink and downlink configuration 3 are configured with one PHICH resource set.

Preferably, wherein for the TDD uplink downlink configuration 3, the timing relationship from UL Grant/PHICH to PUSCH is that the UL Grant/PHICH received on a shortened downlink subframe n is used to schedule the PUSCH on a shortened uplink subframe n+k, where values of k are shown in Table 17,

TABLE 17

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 3 | 6 | 6 | 6 | 6 | 6 | 6; |

the timing relationship from PUSCH to PHICH is that the PHICH corresponding to the PUSCH transmitted on a shortened uplink subframe n is transmitted on a shortened downlink subframe n+k′, where values of k′ are shown in Table 18,

TABLE 18

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | |
|---|---|---|---|---|---|---|---|
| 3 | 14 | 14 | 14 | 14 | 14 | 14 | ; |

### Or,

for the TDD uplink and downlink configuration 3, the timing relationship from UL Grant/PHICH to PUSCH is that the UL Grant/PHICH received on a shortened downlink subframe n is used to schedule the PUSCH on a shortened uplink subframe n+k, where values of k are shown in Table 19,

TABLE 19

| | Shortened Downlink Subframe for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 3 | 7 | 7 | 7 | 7 | 7 | 7; |

the timing relationship from PUSCH to PHICH is that the PHICH corresponding to the PUSCH transmitted on a shortened uplink subframe n is transmitted on a shortened downlink subframe n+k′, where values of k′ are shown in Table 20,

TABLE 20

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | |
|---|---|---|---|---|---|---|---|
| 3 | 13 | 13 | 13 | 13 | 13 | 13 | . |

Preferably, where s1=s2=2.5.

Preferably, wherein the timing relationship from UL Grant/PHICH to PUSCH is that the UL Grant/PHICH received on a shortened downlink subframe n is used to schedule the PUSCH on a shortened uplink subframe n+k, where values of k are shown in Table 21,

TABLE 21

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | |
|---|---|---|---|---|---|---|---|
| 0 | 5 | 5 | 5 | 5 | 5 | 5 | |
| 1 | 5 | 5 | 5 | 5 | 5 | 5 | |
| 2 | 5 | | | 5 | | | |
| 3 | 5 | 5 | 5 | | | | |
| 4 | 5 | 5 | 5 | | | | |
| 5 | 5 | | | | | | |
| 6 | 5 | 5 | 5 | 5 | 5 | 5 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 22,

TABLE 22

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | |
|---|---|---|---|---|---|---|---|
| 0 | 5 | 5 | 5 | 5 | 5 | 5 | |
| 1 | 5 | 5 | 5 | 5 | 5 | 5 | |
| 2 | 5 | | | 5 | | | |
| 3 | 15 | 15 | 15 | | | | |
| 4 | 15 | 15 | 15 | | | | |
| 5 | 15 | | | | | | |
| 6 | 5 | 5 | 5 | 5 | 5 | 5 | . |

Preferably, wherein the timing relationship from UL Grant/PHICH to PUSCH is that the UL Grant/PHICH received on a shortened downlink subframe n is used to schedule the PUSCH on a uplink subframe n+k, where values of k are shown in Table 23,

TABLE 23

| | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 5 | 5 | 5 | | 5 | 5 | 5 | |
| 1 | 5 | 5 | 5 | 5 | 5 | 5 | 5 | 5 |
| 2 | 5 | | | 5 | 5 | | | 5 |
| 3 | 5 | 5 | 5 | | | | | 5 |
| 4 | 5 | 5 | 5 | | | | | 5 |
| 5 | 5 | | | | | | | 5 |
| 6 | 5 | 5 | 5 | | 5 | 5 | 5 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 24,

TABLE 24

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | | 5 | 5 | 5 | | 5 | 5 | 5 |
| 1 | 5 | 5 | 5 | 5 | 5 | 5 | 5 | 5 |
| 2 | 5 | 5 | | | 5 | 5 | | |
| 3 | 15 | 15 | 15 | 15 | | | | |
| 4 | 15 | 15 | 15 | 15 | | | | |
| 5 | 15 | 15 | | | | | | |
| 6 | | 5 | 5 | 5 | | 5 | 5 | 5 |

wherein for TDD uplink and downlink configurations 0 and 6, the timing relationship from UL Grant/PHICH to PUSCH is that the UL Grant/PHICH received on a shortened downlink subframe n is used to schedule a PUSCH on a shortened uplink subframe n+k, where values of k are shown in Table 25,

TABLE 25

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | |
|---|---|---|---|---|---|---|---|---|---|
| 0 | 5 | 5 | 5 | 5 | 5 | 5 | 5 | 5 | |
| 6 | 5 | 5 | 5 | 5 | 5 | 5 | 5 | 5 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 26,

TABLE 26

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | |
|---|---|---|---|---|---|---|---|---|---|
| 0 | 5 | 5 | 5 | 5 | 5 | 5 | 5 | 5 | |
| 6 | 5 | 5 | 5 | 5 | 5 | 5 | 5 | 5 | ; |

for shortened downlink subframes 0, 1, 10 and 11 in the TDD uplink and downlink configuration 0, two PHICH resource sets are configured, and for shortened downlink subframes 2, 3, 12, and 13, one PHICH resource set is configured.

Preferably, wherein the UL Grant comprises an uplink hybrid automatic retransmission request (UL HARQ) process identification to indicate data blocks which belong to a same UL HARQ process; and

the UE, after receiving the PUSCH data, combines and decodes PUSCH data having a same UL HARQ process identification.

Preferably, wherein the method further comprises: transmitting, by the UE, a PUSCH of a first subframe length;

wherein the UE sends the PUSCH of the first subframe length and the PUSCH of the shortened subframe length on a same subframe; or

the UE determines whether to transmit the PUSCH of the first subframe length and the PUSCH of the shortened subframe length on the same subframe according to higher layer signaling configuration; or

the UE does not transmit the PUSCH of the first subframe length and the PUSCH of the shortened subframe length on the same subframe; and when the UE receives scheduling for the PUSCH of the first subframe length and scheduling for the PUSCH of the shortened subframe length on a same uplink subframe, the UE determines to transmit the PUSCH of the first subframe length or the PUSCH of the shortened subframe length according to preset priorities; or

when power of the UE is not restricted, the UE is allowed to transmit the PUSCH of the first subframe length and the PUSCH of the shortened subframe length on the same subframe; and when power of the UE is restricted, power is allocated for the PUSCH of the first subframe length or the PUSCH of the shortened subframe length for transmission according to preset priorities; or

the UE receives physical layer signaling in a public searching space or in a UE-specific searching space, and determines whether to allow the PUSCH of the first subframe length and the PUSCH of the shortened subframe length to be transmitted on a same subframe according to the physical layer signaling; wherein the physical layer signaling comprises indication information on whether the PUSCH of the first subframe length can be transmitted; and

wherein the first subframe length is 1 ms, and the first subframe length is larger than the shortened subframe length.

Preferably, wherein when the UE transmits the PUSCH of the first subframe length and the PUSCH of the shortened subframe length on the same subframe,

the PUSCH of the first subframe length and the PUSCH of the shortened subframe length occupy different resource blocks;

when the PUSCH of the first subframe length is scheduled, preset resources are reserved for the PUSCH of the shortened subframe length; and

when resources scheduled for the PUSCH of the first subframe length and for the PUSCH of the shortened subframe length overlap, transmission of the PUSCH of the first subframe length is stopped, and resources scheduled are used for transmitting the PUSCH of the shortened subframe length.

Preferably, wherein the method further comprises: transmitting, by the UE, a physical uplink control channel (PUCCH) of the first subframe length and a PUCCH of the shortened subframe length;

wherein the PUCCH of the first subframe length and the PUCCH of the shortened subframe length occupy different PUCCH channels, and are allowed to be transmitted on a same uplink subframe; or

the PUCCH of the first subframe length and the PUCCH of the shortened subframe length are not transmitted on a same uplink subframe, and when the PUCCH of the first subframe length and the PUCCH of the shortened subframe length are scheduled on a same uplink subframe, one of the PUCCH of the first subframe length and the PUCCH of the shortened subframe length is selected for transmission according to priorities; or

whether the PUCCH of the first subframe length and the PUCCH of the shortened subframe length can be transmitted on a same uplink subframe is determined according to higher layer signaling; or

the PUCCH of the first subframe length and the PUCCH of the shortened subframe length occupy a same PUCCH channel, and the PUCCH of the first subframe length and the PUCCH of the shortened subframe length are coded together to be transmitted on a same uplink subframe.

Preferably, wherein the PUCCH of the first subframe length and the PUSCH of the shortened subframe length are allowed to be transmitted on a same uplink subframe, and the PUCCH of the shortened subframe length and the PUSCH of the first subframe length are allowed to be transmitted on a same uplink subframe; or

higher layer signaling configures whether the PUCCH of the first subframe length and the PUSCH of the shortened subframe length are allowed to be transmitted on a same uplink subframe, and whether the PUCCH of the shortened subframe length and the PUSCH of the shortened subframe length are allowed to be transmitted on a same uplink subframe; or

the PUCCH of the first subframe length and the PUSCH of the shortened subframe length are not transmitted on a same uplink subframe, and the PUCCH of the shortened subframe length and the PUSCH of the first subframe length are not transmitted on a same uplink subframe; when the PUCCH of the first subframe length and the PUSCH of the shortened subframe length are scheduled on a same uplink subframe, one of the PUCCH of the first subframe length and the PUSCH of the shortened subframe length is selected for transmission according to a preset priority; and when the PUCCH of the shortened subframe length and the PUSCH of the first subframe length are scheduled on a same uplink subframe, one of the PUCCH of the shortened subframe length and the PUSCH of the first subframe length is selected for transmission according to a preset priority; or

the PUCCH of the first subframe length and the PUSCH of the shortened subframe length are allowed to be transmitted on a same uplink subframe, and the PUCCH of the shortened subframe length and the PUSCH of the first subframe length are allowed to be transmitted on a same uplink subframe, and are transmitted on a PUSCH channel.

Preferably, wherein whether the PUCCH of the first subframe length and the PUSCH of the first subframe length are allowed to be transmitted on a same uplink subframe and whether the PUCCH of the first subframe length and the PUSCH of the first subframe length are allowed to be transmitted on a same uplink subframe are determined according to higher layer signaling; or

the PUCCH of the first subframe length and the PUSCH of the first subframe length are not transmitted on a same uplink subframe, and the PUCCH of the first subframe length and the PUSCH of the first subframe length are not transmitted on a same uplink subframe; when the PUCCH of the first subframe length and the PUSCH of the first subframe length need to be transmitted on a same uplink subframe, HARQ of a physical downlink shared channel (PDSCH) of the first subframe length borne by the PUCCH of the first subframe length is transmitted on a PUSCH channel;

and when the PUCCH of the shortened subframe length and the PUSCH of the shortened subframe length need to be transmitted on a same uplink subframe, HARQ of the PDSCH of the first subframe length borne by the PUCCH of the shortened subframe length is transmitted on a PUSCH channel.

A user equipment (UE) for transmitting physical uplink shared channels (PUSCHs), comprising: a receiving configuration unit, a timing determination unit, a detection unit, and a sending unit;

wherein the receiving configuration unit is configured to receive configuration information from a base station, and the configuration information is used to configure an operation mode of the UE to operate on shortened subframes;

the timing determination unit is configured to determine a timing relationship from UL Grant to PUSCH, a timing relationship from PHICH to PUSCH, and a timing relationship from PUSCH to PHICH; wherein the timing relationships are used for transmission of PUSCHs on shortened uplink subframes;

the detection unit is configured to detect a UL Grant and/or a PHICH according to the determined timing relationships; and

the sending unit is configured to transmit data of a PUSCH of a shortened uplink subframe based on the detected UL Grant and/or PHICH according to the timing relationships determined.

### Advantageous Effects of Invention

The present disclosure is intended to solve at least one of the foregoing issues, and provides a method and a UE for transmitting PUSCHs of shortened uplink subframes, so that the UE can transmit PUSCHs normally when the UE operates in the shortened subframe operation mode.

### BRIEF DESCRIPTION OF DRAWINGS

FIG. 1 is a schematic diagram of a frame structure of a LTE TDD system;

FIG. 2 is a schematic diagram of a shortened subframe;

FIG. 3 is a schematic diagram of a method for transmitting PUSCHs in a shortened subframe system according to the present disclosure;

FIG. 4 is a schematic diagram of a time interval between a transmission of a PUSCH and a next retransmission or a new transmission of the PUSCH;

FIG. 5 is a schematic diagram of a time interval between a PUSCH of a shortened uplink subframe and a PHICH according to an example of the present disclosure;

FIG. 6 is a schematic diagram of dividing a radio subframe into shortened subframes according to an example of the present disclosure;

FIG. 7 is a schematic diagram of shortening a time interval between a PUSCH and a PHICH of an uplink subframe according to an example of the present disclosure;

FIG. 8 is a schematic diagram of scheduling timing comparison of a PUSCH of a first subframe length and a PUSCH of a shortened subframe length; and

FIG. 9 is a schematic diagram of a basic structure of a user equipment which transmitting PUSCHs according to the present disclosure.

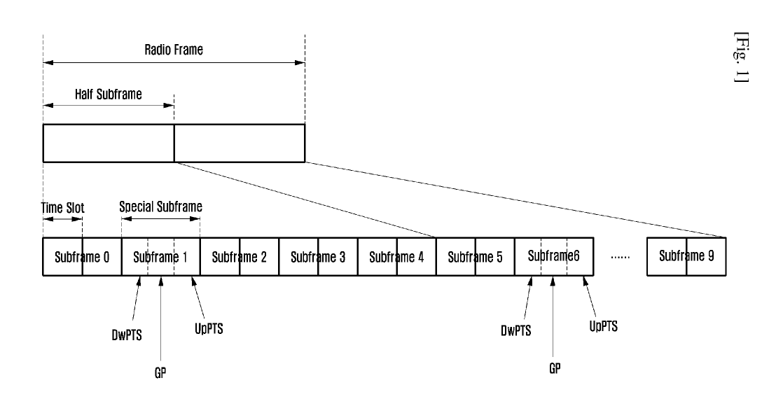

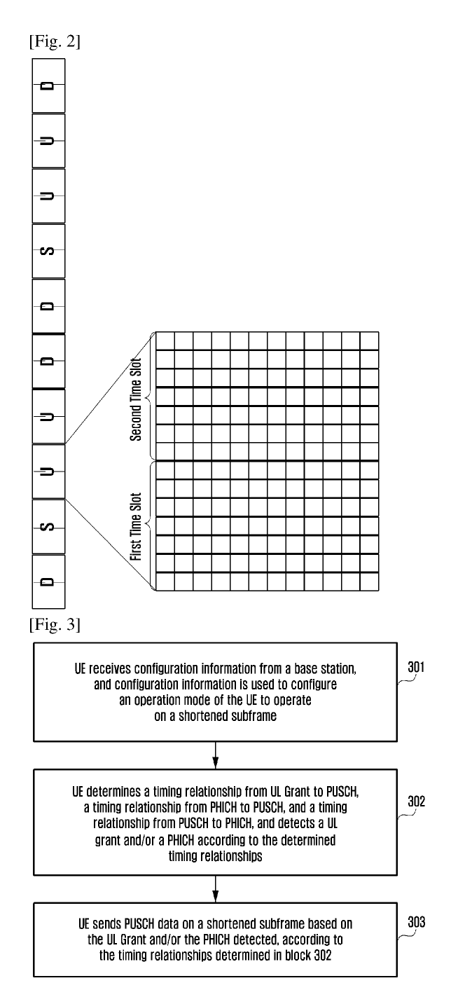

### MODE FOR THE INVENTION

To make the objects, technical schemes and advantages of the present disclosure clearer, the present disclosure will be described in detail hereinafter with reference to the accompanying drawings and embodiments.

The present disclosure is intended for a HARQ timing relationship of PUSCHs in case of shortened subframes.

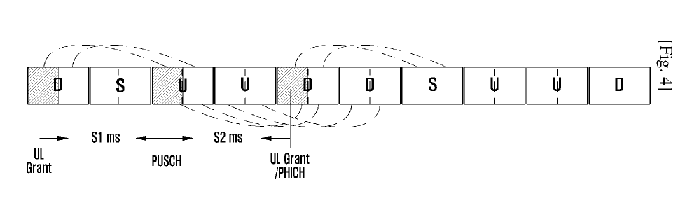

To achieve the objects of the present disclosure, a method for transmitting PUSCHs in a shortened subframe system is provided according to the present disclosure. As shown in FIG. 3, the method includes the following blocks.

Block 301: a UE receives configuration information from a base station, configuration information is to configure a working mode of the UE on a shortened subframe.

Block 302: the UE determines a timing relationship from UL Grant to PUSCH, a timing relationship from PUSCH to PHICH, and detects a UL Grant and/or a PHICH according to the determined timing relationships.

The HARQ timing relationships determined in the current block are used for the PUSCH timing relationship on the shortened uplink subframes. To be specific, a UL Grant is used to schedule a PUSCH on a shortened uplink subframe, and a PHICH is used to bear HARQ indicator information of PUSCH data on a shortened uplink subframe.

Block 303: the UE transmits PUSCH data on a shortened subframe according to the timing relationships determined in block 302 based on the detected UL Grant and/or PHICH.

The technical scheme of the present disclosure will be further described in the following by way of several embodiments.

### Embodiment 1

In the present embodiment, PUSCHs on shortened subframes have a synchronous

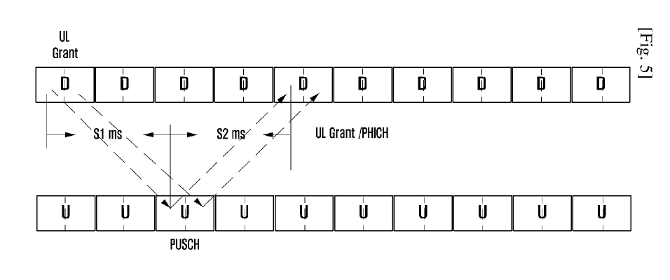

HARQ timing relationship. For the HARQ timing relationship of the PUSCHs on the shortened subframes, an interval from a UL Grant/PHICH received by the UE and a PUSCH transmitted after the UE receives the UL Grant/PHICH is not less than s1 ms, where s1 is configured by higher layer signaling or preset by a protocol, and s1 may be an integer or a decimal, e.g., s1 being equal to 2 ms or 2.5 ms. While an interval between the PUSCH transmitted by the UE and a UL Grant/PHICH received subsequently is not less than s2 ms, where s2 is preset by a protocol or configured by higher layer signaling, and s2 may be an integer or a decimal, e.g., s2 being equal to 2 ms or 2.5 ms. Si may be equal to s2, or may not. In this way, an interval between a transmission of a PUSCH and a next retransmission of it or a transmission of a new PUSCH is not less than s1+s2, as shown in FIG. 4. A length of the shortened subframe may be 0.5 ms, i.e., a time slot, or may be equal to a length of one or several orthogonal frequency division multiplexing (OFDM) symbols, and the length of the shortened subframe is configured by higher layer signaling or preset by a protocol.

For FDD, a UL Grant/PHICH on a shortened downlink subframe schedules a transmission of a PUSCH on a shortened uplink subframe s1 ms after the UL Grant/PHICH; and a PHICH corresponding to the PUSCH transmitted on the shortened uplink subframe is transmitted on a shortened downlink subframe s2 ms after the PUSCH, e.g., s1=s2=2 ms, as shown in FIG. 5. For TDD, all subframes may carry out transmissions of PUSCHs of shortened subframes, or higher layer signaling may configure a part of subframes to carry out transmissions of PUSCHs of shortened subframes.

For TDD, one method is that all of the TDD uplink and downlink configurations 0, 1, 2, 3, 4, 5, and 6 may carry out operations of PUSCHs of shortened subframes. Another method is that a part of the TDD uplink and downlink configurations 0, 1, 2, 3, 4, 5, and 6 may carry out operations of PUSCHs of shortened subframes. For example, the TDD uplink and downlink configurations 0, 1, 2, and 6 may carry out operations of PUSCHs of shortened subframes, and the TDD uplink and downlink configurations 3, 4, and 5 do not support transmissions of PUSCHs of shortened subframes.

For TDD, one method is that all uplink subframes in the respective TDD uplink and downlink configurations may perform PUSCH transmissions of shortened subframes, and another method is that a part of uplink subframes in the respective TDD uplink and downlink configurations may carry out PUSCH transmissions of shortened subframes. For example, which uplink subframes in each TDD uplink and downlink configuration can carry out PUSCH transmissions of shortened subframes may be configured by higher layer signaling, or may be preset by a protocol. For example, all uplink subframes in the TDD uplink and downlink configurations 1, 2, 4, and 5 may perform PUSCH transmissions of shortened subframes, uplink subframes 2, 3, 7, and 8 in the TDD uplink and downlink configurations 0 and 6 may perform PUSCH transmissions of shortened subframes, the other uplink subframes in the TDD uplink and downlink configurations 0 and 6 do not perform PUSCH transmissions of shortened subframes, uplink subframes 2 and 3 in the TDD uplink and downlink configuration 3 may perform PUSCH transmissions of shortened subframes, and the other uplink subframes in the TDD uplink and downlink configuration 3 do not perform PUSCH transmissions of shortened subframes.

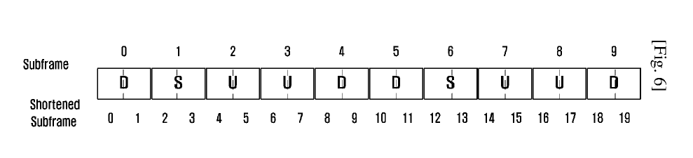

The length of a shortened uplink subframe is a timeslot having a length of 0.5 ms, and each radio frame is divided into 20 shortened subframes having a length of 0.5 ms each, as shown in FIG. 6. Several methods for determining a HARQ timing relationship of PUSCHs of shortened uplink subframes will be described in the following. In the following methods, s1 or s2 is equal to 2 ms.

Method 1:

For all the TDD uplink and downlink configurations, each shortened downlink subframe only schedules a shortened uplink subframe. For timing from UL Grant/PHICH to PUSCH, all the TDD uplink and downlink configurations may adopt same scheduling timing of PUSCHs of shortened subframes; for timing from PUSCH to PHICH, the TDD uplink and downlink configurations 0, 1, 2, and 6 adopt same scheduling timing of PUSCHs of shortened subframes, and the TDD uplink and downlink configurations 3, 4, and 5 adopt same scheduling timing of PUSCHs of shortened subframes. Latency between an initial transmission of a PUSCH of a shortened subframe and a retransmission of it is equal to a downlink-uplink switch period in a TDD uplink and downlink configuration. When such an uplink HARQ timing relationship is adopted, a protocol needs only minor changes, but if a DwPTS of a subframe S only occupies one time slot (i.e., a shortened subframe), the shortened uplink subframe 7 or 17 will not be able to be scheduled.

To be specific, the scheduling timing relationship is that assuming the UE receives a UL Grant on a shortened downlink subframe n (n is a shortened subframe number, i.e., a time slot number, same applying in the following), then the UL Grant is used to schedule a PUSCH within a shortened uplink subframe n+k. Here, values of k are specified in Table 1. If the frame S can be used as 2 shortened downlink subframes, all the shortened uplink subframes in the TDD uplink and downlink configurations 1, 2, 4, and 5 can schedule PUSCH transmissions, the uplink subframes 4 and 9 (i.e., the shortened uplink subframes 8, 9, 18, and 19) in the TDD uplink and downlink configuration 0 will not perform PUSCH transmissions of shortened uplink subframes, the uplink subframe 4 in the TDD uplink and downlink configuration 6 will not perform PUSCH transmissions of shortened uplink subframes, and the uplink subframe 4 in the TDD uplink and downlink configuration 3 will not perform PUSCH transmissions of shortened uplink subframes; and if the frame S can only be used as 1 shortened downlink subframe, then the shortened uplink subframe 7 in the TDD uplink and downlink configurations 0, 1, 3, 4, and 6 and the shortened uplink subframe 17 in the TDD uplink and downlink configurations 0, 1, and 6 will not perform PUSCH transmissions of shortened uplink subframes, the shortened downlink subframe 3 in the TDD uplink and downlink configurations 0, 1, 3, 4, and 6 and the shortened uplink subframe 13 in the TDD uplink and downlink configurations 0, 1, and 6 will not perform UL Grant/PHICH transmissions of shortened downlink subframes.

TABLE 1
Timing Relationship from UL Grant/PHICH to PUSCH

| | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 4 | 4 | 4 | 4 | 4 | 4 | 4 | 4 |
| 1 | 4 | 4 | 4 | 4 | 4 | 4 | 4 | 4 |
| 2 | 4 | 4 | | | 4 | 4 | | |
| 3 | 4 | 4 | 4 | 4 | | | | |
| 4 | 4 | 4 | 4 | 4 | | | | |
| 5 | 4 | 4 | | | | | | |
| 6 | 4 | 4 | 4 | 4 | 4 | 4 | 4 | 4 |

Assuming that the UE transmits a PUSCH on a shortened uplink subframe n (n is a shortened subframe number, i.e., a time slot number), then a PHICH corresponding to the PUSCH is on a shortened downlink subframe n+k. If the frame S can be deemed as two shortened downlink subframes, values of k are specified in Table 2. If the frame S can only be deemed as one shortened downlink subframe, the shortened uplink subframe 7 in the TDD uplink and downlink configurations 0, 1, 3, 4, and 6 and the shortened uplink subframe 17 in the TDD uplink and downlink configurations 0, 1, and 6 do not perform PUSCH transmissions of shortened uplink subframes.

TABLE 2
Timing relationship from PUSCH to PHICH

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 6 | 6 | 6 | 6 | 6 | 6 | 6 | 6 |
| 1 | 6 | 6 | 6 | 6 | 6 | 6 | 6 | 6 |
| 2 | 6 | 6 | | | 6 | 6 | | |
| 3 | 16 | 16 | 16 | 16 | | | | |
| 4 | 16 | 16 | 16 | 16 | | | | |
| 5 | 16 | 16 | | | | | | |
| 6 | 6 | 6 | 6 | 6 | 6 | 6 | 6 | 6 |

Method 2:

For all the TDD uplink and downlink configurations, except for the DwPTS, each shortened downlink subframe only schedules one shortened uplink subframe, and a first shortened downlink subframe of the subframe S schedules PUSCH transmissions of 2 shortened uplink subframes. For timing from a UL Grant/PHICH to a PUSCH, all the TDD uplink and downlink configurations may use same scheduling timing of PUSCHs and shortened subframes; and for timing from a PUSCH to a PHICH, the TDD uplink and downlink configurations 0, 1, 2, and 6 use same scheduling timing of PUSCHs of shortened subframes, and the TDD uplink and downlink configurations 3, 4, and 5 use same scheduling timing of PUSCHs of shortened subframes. A first transmission of a PUSCH of a shortened subframe and a retransmission thereof is equal to an uplink-downlink switch period in a TDD uplink and downlink configuration, and when using this method, no matter whether the DwPTS of the subframe S occupies one time slot or two time slots, the shortened uplink subframe 7 or 17 is able to be scheduled.

To be specific, the HARQ timing relationship is that assuming that the UE receives a UL Grant on a shortened downlink subframe n (n is a shortened subframe number, i.e., a time slot number, same applying in the following), then the UL Grant is used to schedule a PUSCH on a shortened uplink subframe n+k. Values of k are specified in Table 3. The shortened downlink subframes 0 and 1 in the TDD uplink and downlink configurations 0, 1, 2, 3, 4, 5, and 6 and the shortened downlink suffrage 10 and 11 in the TDD uplink and downlink configurations 0, 1, 2, and 6 only schedule a PUSCH transmission of one shortened uplink subframe, and the shortened downlink subframe 2 in the TDD uplink and downlink configurations 0, 1, 3, 4, and 6 and the shortened downlink subframe 12 in the TDD uplink and downlink configurations 0, 1, and 6 only schedule PUSCH transmissions on 2 shortened uplink subframes.

TABLE 3
Timing relationship from UL Grant/PHICH to PUSCH

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 0 | 4 | 4 | 4, 5 | 4 | 4 | 4, 5 |
| 1 | 4 | 4 | 4, 5 | 4 | 4 | 4, 5 |
| 2 | 4 | 4 | | 4 | 4 | |
| 3 | 4 | 4 | 4, 5 | | | |
| 4 | 4 | 4 | 4, 5 | | | |
| 5 | 4 | 4 | | | | |
| 6 | 4 | 4 | 4, 5 | 4 | 4 | 4, 5 |

Assuming that the UE transmits a PUSCH on a shortened uplink subframe n (n is a shortened subframe number, i.e., a time slot number), then a PHICH corresponding to the PUSCH is transmitted on a shortened downlink subframe n+k, which when reflected in Table 4 is, that the shortened downlink subframes 0, 1, 10, and 11 in the TDD uplink and downlink configurations 0, 1, 2, and 6 are only configured with one PHICH resource set; the shortened downlink subframes 0 and 1 in the TDD uplink and downlink configurations 3, 4, and 5 are only configured with one PHICH resource set; the shortened downlink subframes 2 and 12 in the TDD uplink and downlink configurations 0, 1, and 6 are configured with two PHICH resource sets; and the shortened downlink subframe 2 in the TDD uplink and downlink configurations 3 and 4 are configured with two PHICH resource sets. PUSCHs of the shortened uplink subframes 4 and 5 in the TDD uplink and downlink configurations 0, 1, 2, 3, 4, 5, and 6, a PUSCH of the shortened uplink subframe 6 in the TDD uplink and downlink configurations 0, 1, 3, 4, and 6, PUSCHs of the shortened uplink subframes 14 and 15 in the TDD uplink and downlink configurations 0, 1, 2, and 6, and a PUSCH of the shortened uplink subframe 16 in the TDD uplink and downlink configurations 0, 1, and 6 correspond to the PHICH resource set 0, i.e., IPHICH being equal to 0; and a PUSCH of the shortened uplink subframe 7 in the TDD uplink and downlink configurations 0, 1, 3, 4, and 6 and a PUSCH of the shortened uplink subframe 17 in the TDD uplink and downlink configurations 0, 1, and 6 correspond to the PHICH resource set 1, i.e., IPHICH being equal to 1.

TABLE 4
Timing relationship from PUSCH to PHICH

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 6 | 6 | 6 | 5 | 6 | 6 | 6 | 5 |
| 1 | 6 | 6 | 6 | 5 | 6 | 6 | 6 | 5 |
| 2 | 6 | 6 | | | 6 | 6 | | |
| 3 | 16 | 16 | 16 | 15 | | | | |
| 4 | 16 | 16 | 16 | 15 | | | | |
| 5 | 16 | 16 | | | | | | |
| 6 | 6 | 6 | 6 | 5 | 6 | 6 | 6 | 5 |

Method 3:

For all the TDD uplink and downlink configurations 1, 2, 3, 4, and 5, since the number of the downlink subframes is larger than the number of the uplink subframes, then the downlink subframes are enough to schedule the uplink subframes. To prevent an issue that since the DwPTS of the subframe S only occupies one time slot, the shortened uplink subframe 7 or 17 cannot be scheduled, HARQ timing is changed. The subframe S will not be used for scheduling of an uplink shortened subframe, but other subframes except for the subframe S are used for scheduling of uplink shortened subframes. In this way, no matter whether the DwPTS of the subframe S occupies one time slot or two time slots, other subframes are used to schedule the shortened uplink subframe 7 or 17, so that to guarantee that the shortened uplink subframe 7 or 17 can be scheduled. For the TDD uplink and downlink configurations 0 and 6, since the number of downlink subframes is not larger than the number of uplink subframes, the subframe S is still used to schedule a shortened uplink subframe, and each shortened downlink subframe schedules one shortened uplink subframe. When the DwPTS of the subframe S only occupies one time slot, since there is not a second shortened downlink subframe in the subframe S, the shortened uplink subframe 7 or 17 cannot be scheduled.

The HARQ timing relationship is that, assuming that the UE receives a UL Grant on a shortened downlink subframe n (n is a shortened subframe number, i.e., a time slot number, same applying in the following), then the UL Grant is used to schedule a PUSCH on a shortened uplink subframe n+k. Values of k are specified in Table 5. If the frame S can only be used as one shortened downlink subframe, the shortened downlink subframe 3 and the shortened downlink subframe 13 in the TDD uplink and downlink configurations 0 and 6 do not transmit a UL Grant/PHICH of a shortened downlink subframe.

TABLE 5
Timing Relationship from UL Grant/PHICH to PUSCH

| | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | | | |
|---|---|---|---|---|---|---|---|---|---|---|---|---|
| 0 | 4 | 4 | 4 | 4 | | | 4 | 4 | 4 | 4 | | |
| 1 | 6 | 6 | | | 6 | 6 | 6 | 6 | | | 6 | 6 |
| 2 | 4 | 4 | | | | | 4 | 4 | | | | |
| 3 | 6 | 6 | | | | | | | | | 6 | 6 |
| 4 | 6 | 6 | | | | | | | | | 6 | 6 |
| 5 | 4 | 4 | | | | | | | | | | |
| 6 | 4 | 4 | 4 | 4 | | | 4 | 4 | 4 | 4 | | |

Assume that the UE transmits a PUSCH on a shortened uplink subframe n (n is a shortened subframe number, i.e., a time slot number), then a PHICH corresponding to the PUSCH is within a shortened downlink subframe n+k. If the frame S can be used as two shortened downlink subframes, values of k are specified in Table 6. If the frame S can only be used as one shortened downlink subframe, the shortened uplink subframe 7 and the shortened uplink subframe 17 in the TDD uplink and downlink configurations 0 and 6 will not perform PUSCH transmissions of shortened uplink subframes.

TABLE 6
Timing Relationship from PUSCH to PHICH

| | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 6 | 6 | 6 | 6 | 6 | 6 | 6 | 6 |
| 1 | 6 | 6 | 6 | 6 | 6 | 6 | 6 | 6 |
| 2 | 6 | 6 | | | 6 | 6 | | |
| 0 | 6 | 6 | 6 | 6 | 6 | 6 | 6 | 6 |
| 4 | 16 | 16 | 16 | 16 | | | | |
| 5 | 16 | 16 | | | | | | |
| 6 | 6 | 6 | 6 | 6 | 6 | 6 | 6 | 6 |

Method 4:

For all the TDD uplink and downlink configurations 1, 2, 3, 4, and 5, since the number of the downlink subframes is larger than the number of the uplink subframes, to avoid an issue that since the DwPTS of the subframe S only occupies one time slot, the shortened uplink subframe 7 or 17 cannot be scheduled, similarly to the Method 3, HARQ timing is changed. The subframe S is not used for scheduling of uplink shortened subframes, no matter whether the DwPTS of the subframe S only occupies one time slot or two time slots, the shortened uplink subframe 7 or 17 can be scheduled. For the TDD uplink and downlink configurations 0 and 6, the subframe S will not be used for scheduling of shortened uplink subframes, but each of the shortened downlink subframes 2 and 12 schedules PUSCHs of two shortened uplink subframes. In this way, for all the TDD uplink and downlink configurations, the issue that scheduling is affect as the DwPTS of the subframe S occupies only one time slot will not occur.

The HARQ timing relationship is that assuming that the UE receives a UL Grant on a shortened downlink subframe n (n is a shortened subframe number, i.e., a time slot number, same applying in the following), then the UL Grant is used for scheduling a PUSCH on a shortened uplink subframe n+k. Values of k are specified in Table 7. If the frame S can only be used as one shortened downlink subframe, then the shortened downlink subframe 3 and the shortened downlink subframe 13 in the TDD uplink and downlink configurations 0 and 6 will not transmit a UL Grant/PHICH of a shortened downlink subframe.

TABLE 7
Timing Relationship from UL Grant/PHICH to PUSCH

| | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| Configuration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | |
|---|---|---|---|---|---|---|---|---|---|---|
| 0 | 4 | 4 | 4, 5 | | | 4 | 4 | 4, 5 | | |
| 1 | 6 | 6 | | 6 | 6 | 6 | 6 | | 6 | 6 |
| 2 | 4 | 4 | | | | 4 | 4 | | | |
| 3 | 6 | 6 | | | | | | | 6 | 6 |
| 4 | 6 | 6 | | | | | | | 6 | 6 |
| 5 | 4 | 4 | | | | | | | | |
| 6 | 4 | 4 | 4, 5 | | | 4 | 4 | 4, 5 | | |

Assume that the UE transmits a PUSCH on a shortened uplink subframe n (n is a shortened subframe number, i.e., a time slot number), then a PHICH corresponding to the PUSCH is on a shortened downlink subframe n+k. The shortened downlink subframes 2 and 12 in the TDD uplink and downlink configurations 0 and 6 are configured with 2 PHICH resource sets. The shortened downlink subframes 0, 1, 10, and 11 in the TDD uplink and downlink configurations 0 and 6 and the shortened downlink subframes of other TDD uplink and downlink configurations are configured with one PHICH resource set.

TABLE 8
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 6 | 6 | 6 | 5 | 6 | 6 | 6 | 5 |
| 1 | 4 | 4 | 4 | 4 | 4 | 4 | 4 | 4 |
| 2 | 6 | 6 | | | 6 | 6 | | |
| 3 | 14 | 14 | 14 | 14 | | | | |
| 4 | 14 | 14 | 14 | 14 | | | | |
| 5 | 16 | 16 | | | | | | |
| 6 | 6 | 6 | 6 | 5 | 6 | 6 | 6 | 5 |

Method 5:

For the TDD uplink and downlink configurations 0, 3, and 6, since the number of the uplink subframes is larger than the number of the downlink subframes, in the foregoing methods, there are no operations of shortened uplink subframes on some uplink subframes, e.g., there being no operations of shortened uplink subframes on the uplink subframes 4 and 9 in the TDD uplink and downlink configuration 0, the uplink subframe 4 in the TDD uplink and downlink configuration 3, and the uplink subframe 9 in the TDD uplink and downlink configuration 6. In the Method 5, synchronization and timing of a PUSCH are designed, which enables all the uplink subframes to perform PUSCH transmissions of shortened uplink subframes.

To be specific, for the TDD uplink and downlink configuration 0, a timing relationship is that assuming that the UE receives a UL Grant on a shortened downlink subframe n (n is a shortened subframe number, i.e., a time slot number), then the UL Grant is used for scheduling a PUSCH in a shortened uplink subframe n+k. Values of k are specified in Table 9. If the frame S can only be used as one shortened downlink subframe, the shortened downlink suffrage 3 and the shortened downlink subframe 13 in the TDD uplink and downlink configuration 0 do not transmit a UL Grant/PHICH of a shortened downlink subframe, and the shortened uplink subframes 9 and 19 do not transmit a PUSCH.

TABLE 9
Timing Relationship from UL Grant/PHICH to PUSCH

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 4, 5 | 5, 6 | 6 | 6 | 4, 5 | 5, 6 | 6 | 6 |

Assume that the UE transmits a PUSCH on a shortened uplink subframe n (n is a shortened subframe number, i.e., a time slot number), then a PHICH corresponding to the PUSCH is transmitted on a shortened downlink subframe n+k, as shown in Table 10. The shortened downlink subframes 0, 1, 10, and 11 in the TDD uplink and downlink configuration 0 are configured with 2 PHICH resource sets. The downlink subframes 2, 3, 12, and 13 in the TDD uplink and downlink configuration 0 are configured with 1 PHICH resource set.

TABLE 10
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | | | |
|---|---|---|---|---|---|---|---|---|---|---|---|---|
| 0 | 6 | 5 | 5 | 4 | 4 | 4 | 6 | 5 | 5 | 4 | 4 | 4 |

For the TDD uplink and downlink configuration 6, a HARQ timing relationship is that assuming that the UE receives a UL Grant on a shortened downlink subframe n (n is a shortened subframe number, i.e., a time slot number), then the UL Grant is used to schedule a PUSCH on a shortened uplink subframe n+k. Values of k are specified in Table 11. If the frame S can only be used as one shortened downlink subframe, then the shortened downlink subframe 3 and the shortened downlink subframe in the TDD uplink and downlink configuration 6 will not transmit a UL Grant/PHICH of a shortened downlink subframe, and the shortened uplink subframes 9 and 17 do not transmit a PUSCH.

TABLE 11
Timing Relationship from UL Grant/PHICH to PUSCH

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 6 | 4, 5 | 5, 6 | 6 | 6 | 4 | 4 | 4 | 4 |

Assuming that the UE transmits a PUSCH on a shortened uplink subframe n (n is a shortened subframe number, i.e., a time slot number), then a PHICH corresponding to the PUSCH is on a shortened downlink subframe n+k, as shown in Table 12. The shortened downlink subframes 0, 1, 2, 3, 12, and 13 in the TDD uplink and downlink configuration 6 are configured with 1 PHICH resource set, and the shortened downlink subframes 10 and 11 in the TDD uplink and downlink configuration 6 are configured with 2 PHICH resource sets.

TABLE 12
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | |
|---|---|---|---|---|---|---|---|---|---|---|
| 6 | 6 | 5 | 5 | 4 | 4 | 4 | 6 | 6 | 6 | 6 |

Or, for the TDD uplink and downlink configuration 6, another HARQ timing relationship is that assuming that the UE receives a UL Grant on a shortened downlink subframe n (n is a shortened subframe number, i.e., a time slot number), then the UL Grant is used to schedule a PUSCH on a shortened uplink subframe n+k. Values of k are specified in Table 13. Assume that the frame S can only be used as one shortened downlink subframe, then the shortened downlink subframe 3 in the TDD uplink and downlink configuration 6 does not transmit a UL Grant/PHICH of a shortened downlink subframe, and the shortened uplink subframe 9 does not transmit a PUSCH, and since the shortened downlink subframe 12 transmits a UL Grant/PHICH of a shortened downlink subframe to schedule a PUSCH on the shortened uplink subframes 16 and 17, the shortened uplink subframe 17 is used to transmit a PUSCH.

TABLE 13
Timing Relationship from UL Grant/PHICH to PUSCH

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | |
|---|---|---|---|---|---|---|---|
| 6 | 4, 5 | 5, 6 | 6 | 6 | 4 | 4 | 4, 5 |

Assume that the UE transmits a PUSCH on a shortened uplink subframe n (n is a shortened subframe number, i.e., a time slot number), then a PHICH corresponding to the PUSCH is transmitted on a shortened downlink subframe n+k, as shown in Table 14. The shortened downlink subframes 0, 1, 12, and 13 in the TDD uplink and downlink configuration 6 are configured with 1 PHICH resource set, and the shortened downlink subframes 2, 10, and 11 in the TDD uplink and downlink configuration 6 are configured with 2 PHICH resource sets.

TABLE 14
Timing Relationship from PUSCH to PHICH

| Config- | Shortened uplink subframe n for PUSCH transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | | | |
|---|---|---|---|---|---|---|---|---|---|---|
| 6 | 6 | 5 | 5 | 4 | 4 | 4 | 6 | 6 | 6 | 5 |

For the TDD uplink and downlink configuration 3, a HARQ timing relationship is that assuming that the UE receives a UL Grant on a shortened downlink subframe n (n is a shortened subframe number, i.e., time slot number), then the UL Grant is used to schedule a PUSCH on a shortened uplink subframe n+k. Values of k are specified in Table 15. Assuming that the frame S can only be used as 1 shortened downlink subframe, then the shortened downlink subframe 3 in the TDD uplink and downlink configuration 3 does not transmit a UL Grant/PHICH of a shortened downlink subframe, and the shortened uplink suffrage 9 does not transmit a PUSCH.

TABLE 15
Timing Relationship From UL Grant/PHICH to PUSCH

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | |
|---|---|---|---|---|
| 3 | 4, 5 | 5, 6 | 6 | 6 |

Assuming that the UE transmits a PUSCH on a shortened uplink subframe n (n is a shortened subframe number, i.e., a time slot number), a PHICH corresponding to the PUSCH is transmitted on a shortened downlink subframe n+k, as shown in Table 16. The shortened downlink subframes 0 and 1 in the TDD uplink and downlink configuration 3 are configured with 2 PHICH resource sets. The shortened downlink subframes 2 and 3 in the TDD uplink and downlink configuration 3 is configured with 1 PHICH resource set.

TABLE 16
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 3 | 16 | 15 | 15 | 14 | 14 | 14 |

In the foregoing Method 5, the timing relationships of the TDD uplink and downlink configurations 0, 3, and 6 can be used in combination with the timing relationships of the TDD uplink and downlink configurations 1, 2, 4, and 5 in the foregoing four methods.

Method 6:

For the TDD uplink and downlink configuration 3, in this method, all the uplink subframes may perform PUSCH transmissions of shortened uplink subframes.

For the TDD uplink and downlink configuration 3, a HRAQ timing relationship is that assuming that the UE receives a UL Grant on a shortened downlink suffrage n (n is a shortened subframe number, i.e., a time slot number), then the UL Grant is used to schedule a PUSCH on a shortened uplink subframe n+k. Values of k are specified in Table 17. If the frame S can only be used as 1 shortened downlink subframe, then the shortened downlink subframe 3 in the TDD uplink and downlink configuration 3 does not transmit a UL Grant/PHICH of a shortened downlink subframe, and the shortened uplink subframe 9 does not transmit a PUSCH.

TABLE 17
Timing Relationship from UL Grant/PHICH to PUSCH

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 3 | 6 | 6 | 6 | 6 | 6 | 6 |

Assuming that the UE transmits a PUSCH on a shortened uplink subframe n (n is a shortened subframe number, i.e., a time slot number), then a PHICH corresponding to the PUSCH is transmitted on a shortened downlink subframe n+k, as shown in Table 18. The shortened downlink subframes 0, 1, 2, 3, 18, and 19 in the TDD uplink and downlink configuration 3 are configured with 1 PHICH resource set.

TABLE 18
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 3 | 14 | 14 | 14 | 14 | 14 | 14 |

In the foregoing Method 6, the timing relationship of the TDD uplink and downlink configuration 3 may be used in combination with any timing relationship of the TDD uplink and downlink configurations 0, 1, 2, 4, 5, and 6 in the foregoing four methods, and may also be used in combination with any timing relationship of the TDD uplink and downlink configurations 0 and 6 in the foregoing Method 5.

Method 7:

For the TDD uplink and downlink configuration 3, in this method, all the uplink subframes may perform a PUSCH transmission of a shortened uplink subframe, logic of which is that considering a DwPTS may not have a second time slot, it is changed to n+7, RTT is increased, guaranteeing that all the shortened subframes can be scheduled.

For the TDD uplink and downlink configuration 3, a HARQ timing relationship is that assuming that the UE receives a UL Grant on a shortened downlink subframe n (n is a shortened subframe number, i.e., a time slot number), then the UL Grant is used to schedule a PUSCH on a shortened uplink subframe n+k. Values of k are specified in Table 19.

TABLE 19
Timing Relationship from UL Grant/PHICH to PUSCH

| Config- | Shortened Downlink Subframe for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 3 | 7 | 7 | 7 | 7 | 7 | 7 |

Assuming that the UE transmits a PUSCH on a shortened uplink suffrage n (n is a shortened subframe number, i.e., a time slot number), then a PHICH corresponding to the PUSCH is transmitted on a shortened downlink subframe n+k, as shown in Table 20. The shortened downlink subframes 0, 1, 2, 3, 17, 18, and 19 in the TDD uplink and downlink configuration 3 are configured with 1 PHICH resource set.

TABLE 20
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 3 | 13 | 13 | 13 | 13 | 13 | 13 |

The timing relationship in the TDD uplink and downlink configuration 3 of the Method 7 may be used in combination with any timing relationship in the TDD uplink and downlink configurations 0, 1, 2, 4, 5, and 6 in the foregoing four methods, or may be used in combination with any timing relationship in the TDD uplink and downlink configurations 0 and 6 in the Method 5.

### Embodiment 2

In the present embodiment, PUSCHs on shortened subframes maintain a synchronous HARQ timing relationship. For a HARQ timing relationship of a PUSCH of a shortened subframe, an interval between the UE receiving a UL Grant/PHICH and the UE transmitting a PUSCH according to received UL Grant/PHICH information is not smaller than s1 ms, where s1 is configured by higher layer signaling or preset by a protocol, and s1 may be an integer or a decimal, e.g., s1 being equal to 2.5 ms. While an interval between the UE sending the PUSCH and the UE receiving a UL Grant/PHICH subsequently is not smaller than s2 ms, where s2 is configured by higher layer signaling or preset by a protocol, and s2 may be an integer or a decimal, e.g., s2 being equal to 2.5 ms. In this case, an interval of a transmission of a PUSCH and a next retransmission or a new transmission of the PUSH is not smaller than s1+s2, as shown in FIG. 4. A length of a shortened subframe may be 0.5 ms, i.e., a time slot, or may be a length of one or several OFDM symbols. The length of the shortened subframe may be configured by a higher layer, or preset by a protocol.

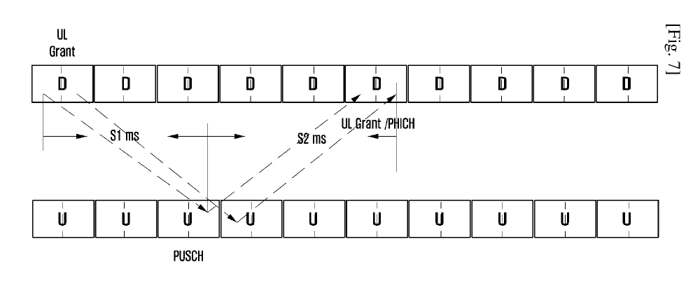

For FDD, a UL Grant/PHICH on a shortened downlink subframe schedules a PUSCH transmission on a shortened uplink subframe s1 ms after the UL Grant/PHICH; and a PHICH corresponding to the PUSCH transmitted on the shortened uplink subframe is transmitted on a shortened downlink subframe which is s2 ms later than the PUSCH, e.g., s1=s2=2.5 ms, as shown in FIG. 7. For FDD, all subframes may perform transmissions of PUSCHs of shortened subframes, or higher layer signaling may configure a part of subframes to perform transmissions of PUSCHs of the shortened subframes.

For TDD, a UL Grant/PHICH on a shortened downlink subframe schedules a transmission of a PUSCH on a shortened uplink subframe s1 ms after the UL Grant/PHICH; and a PHICH corresponding to the PUSCH transmitted on the shortened uplink subframe is transmitted on a shortened downlink subframe s2 ms after the PUSCH, e.g., s1=s2=2.5 ms. A length of a shortened uplink subframe is a time slot of 0.5 ms, and each radio frame is divided into 20 shortened subframes of 0.5 ms each, as shown in FIG. 6. In the following, several methods for determining a HARQ timing relationship of PUSCHs of shortened uplink subframes are described. In the following methods, s1=s2=2.5.

Method 1:

For all the TDD uplink and downlink configurations, each shortened downlink subframe only schedules a shortened uplink subframe. For timing from a UL Grant/PHICH to a PUSCH, all the TDD uplink and downlink configurations may use same scheduling timing of PUSCHs of shortened subframes; and for timing from a PUSCH to a PHICH, the TDD uplink and downlink configurations 0, 1, 2, and 6 use same scheduling timing of PUSCHs of shortened subframes, and the TDD uplink and downlink configurations 3, 4, and 5 use same scheduling timing of PUSCHs of shortened subframes. Latency between a first transmission of a PUSCH of a shortened subframe and a retransmission thereof is equal to a downlink-uplink switch period of a TDD uplink and downlink configuration. Using such an uplink HARQ timing relationship, a protocol needs only minor changes, but if a DwPTS of a subframe S only occupies one time slot (i.e., a shortened subframe), but some shortened uplink subframes cannot be scheduled. The HARQ timing relationship is that assuming that the UE receives a UL Grant on a shortened downlink subframe n (n is a shortened subframe number, i.e., a time slot number, same applying in the following), then the UL Grant is used to schedule a PUSCH on a shortened uplink subframe n+k. Values of k are specified in Table 21.

TABLE 21
Timing Relationship from UL Grant/PHICH to PUSCH

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 0 | 5 | 5 | 5 | 5 | 5 | 5 |
| 1 | 5 | 5 | 5 | 5 | 5 | 5 |
| 2 | 5 | | | 5 | | |
| 3 | 5 | 5 | 5 | | | |
| 4 | 5 | 5 | 5 | | | |
| 5 | 5 | | | | | |
| 6 | 5 | 5 | 5 | 5 | 5 | 5 |

Assuming that the UE transmits a PUSCH on a shortened uplink subframe n (n is a shortened subframe number, i.e., a time slot number), then a PHICH corresponding to the PUSCH is transmitted on a shortened downlink subframe n+k. Values of k are specified in Table 22.

TABLE 22
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | |
|---|---|---|---|---|---|---|
| 0 | 5 | 5 | 5 | 5 | 5 | 5 |
| 1 | 5 | 5 | 5 | 5 | 5 | 5 |
| 2 | 5 | | | 5 | | |
| 3 | 15 | 15 | 15 | | | |
| 4 | 15 | 15 | 15 | | | |
| 5 | 15 | | | | | |
| 6 | 5 | 5 | 5 | 5 | 5 | 5 |

Method 2:

For the TDD uplink and downlink configurations 1, 2, 4, and 5, since the number of the downlink subframes is larger than the number of the downlink subframes, all the shortened uplink subframes can be scheduled, but for the TDD uplink and downlink configurations 0, 3, and 6, some shortened uplink subframes cannot be scheduled.

The HARQ timing relationship is that assuming that the UE receives a UL Grant on a shortened downlink subframe n (n is a shortened subframe number, i.e., a time slot number, same applying in the following), then the UL Grant is used to schedule a PUSCH on a shortened uplink subframe n+k. Values of k are specified in Table 23.

TABLE 23
Timing Relationship from UL Grant/PHICH to PUSCH

| Config- | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 5 | 5 | 5 | | 5 | 5 | 5 | |
| 1 | 5 | 5 | 5 | 5 | 5 | 5 | 5 | 5 |
| 2 | 5 | | | 5 | 5 | | | 5 |
| 3 | 5 | 5 | 5 | | | | | 5 |
| 4 | 5 | 5 | 5 | | | | | 5 |
| 5 | 5 | | | | | | | 5 |
| 6 | 5 | 5 | 5 | | 5 | 5 | 5 | |

Assume that the UE transmits a PUSCH on a shortened uplink subframe n (n is a shortened subframe number, i.e., a time slot number), then a PHICH corresponding to the PUSCH is on a shortened downlink subframe n+k. Values of k are specified in Table 24.

TABLE 24
Timing Relationship from PUSCH to PHICH

| Config- | Shortened Uplink Subframe n for PUSCH transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | | 5 | 5 | 5 | | 5 | 5 | 5 |
| 1 | 5 | 5 | 5 | 5 | 5 | 5 | 5 | 5 |
| 2 | 5 | 5 | | | 5 | 5 | | |
| 3 | 15 | 15 | 15 | 15 | | | | |
| 4 | 15 | 15 | 15 | 15 | | | | |
| 5 | 15 | 15 | | | | | | |
| 6 | | 5 | 5 | 5 | | 5 | 5 | 5 |

Method 3:

For the TDD uplink and downlink configurations 0 and 6, since s1 and s2 are not smaller than 2.5 ms, then a shortened downlink subframe cannot schedule two shortened uplink subframes.

For the TDD uplink and downlink configurations 0 and 6, a HARQ timing relationship is that assuming that the UE receives a UL Grant on a shortened downlink subframe n (n is a shortened subframe number, i.e., a time slot number), then the UL Grant is used to schedule a PUSCH on a shortened uplink subframe n+k. Values of k are specified in Table 25. If the frame S is used as 2 shortened downlink subframes, the shortened downlink subframe 3 and the shortened downlink subframe 13 in the TDD uplink and downlink configurations 0 and 6 are used to transmit a UL Grant/PHICH of a shortened downlink subframe, and the shortened uplink subframes 8 and 18 may be used to transmit a PUSCH.

TABLE 25
Timing Relationship from UL Grant/PHICH to PUSCH

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 5 | 5 | 5 | 5 | 5 | 5 | 5 | 5 |
| 6 | 5 | 5 | 5 | 5 | 5 | 5 | 5 | 5 |

Assuming that the UE transmits a PUSCH on a shortened uplink subframe n (n is a shortened subframe number, i.e., a time slot number), then a PHICH corresponding to the PUSCH is on a shortened downlink subframe n+k, as shown in Table 26. The shortened downlink subframes 0, 1, 10, and 11 in the TDD uplink and downlink configuration 0 are configured with 2 PHICH resources sets. The shortened downlink subframes 2, 3, 12, and 13 in the TDD uplink downlink configuration 0 are configured with 1 PHICH resource set.

TABLE 26
Timing Relationship from PUSCH to PHICH

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |

| | | | | | | | | |
|---|---|---|---|---|---|---|---|---|
| 0 | 5 | 5 | 5 | 5 | 5 | 5 | 5 | 5 |
| 6 | 5 | 5 | 5 | 5 | 5 | 5 | 5 | 5 |

The timing relationships of the TDD uplink and downlink configurations 0 and 6 in the Method 3 of the Embodiment 2 may be used in combination with the timing relationships of the TDD uplink and downlink configurations 1, 2, 3, 4, and 5 in the foregoing two methods of the Embodiment 2.

### Embodiment 3

In this embodiment, PUSCHs on shortened uplink subframes maintain an asynchronous HARQ timing relationship. The PUSCHs on the shortened uplink subframes maintaining the asynchronous HARQ timing relationship means that a timing relationship between a UL Grant received by the UE on a shortened downlink subframe and a subsequent PUSCH scheduled by the UL Grant is definite. The detailed timing relationship is as those in the HARQ timing relationships between the UL Grant received on the shortened downlink subframe and the subsequent PUSCH scheduled by the UL Grant in the Methods 1 to 7 of the Embodiment 1. While which transmissions of PUSCHs belong to a first transmission of a same block and its retransmission, i.e., transmissions of these PUSCHs can be combined to be decoded. In a UL Grant which schedules a PUSCH of a shortened uplink subframe, a UL HARQ process identification is introduced to indicate which data blocks belong to a same UL HARQ process. The UL HARQ process identification is M bits. One situation is that for all the TDD UL/DL configurations, the UL HARQ process identification is M bits, e.g. M being equal to 3 bits; and another situation is that for different TDD UL/DL configurations, the number of bits of the UL HARQ process identification is different, e.g., for the TDD UL/DL configurations 0 and 6, the UL HARQ process identification being equal to 3 bits, and for the TDD UL/DL configurations 1, 2, 3, 4, and 5, the UL HARQ process identification being 2 bits.

### Embodiment 4

In this embodiment, transmissions of a PUCCH and a PUSCH of a first subframe (a subframe which is 1 ms long) length and transmissions of a PUCCH and a PUSCH of a shortened subframe (a subframe which is smaller than 1 ms, e.g., a subframe of 0.5 ms) length will be discussed. Then, a first issue is that for a serving cell, for a UE, whether a PUSCH of the first subframe length and a PUSCH of the shortened subframe length can be simultaneously transmitted on a same subframe; another issue is that whether a PUCCH (used for bearing HARQ of a PDSCH of the first subframe length) of the first subframe length and a PUCCH (used for bearing HARQ of a PDSCH of the shortened subframe length) of shortened subframe length can be simultaneously transmitted on a same subframe; and still another issue is that whether a PUCCH of the first subframe length and a PUSCH of the shortened subframe length can be simultaneously transmitted on a same subframe at the same time. The description of all these issues will be provided in the following.

First, a method for transmitting a PUSCH of the first subframe length and a PUSCH of the shortened subframe length on a same subframe is described.

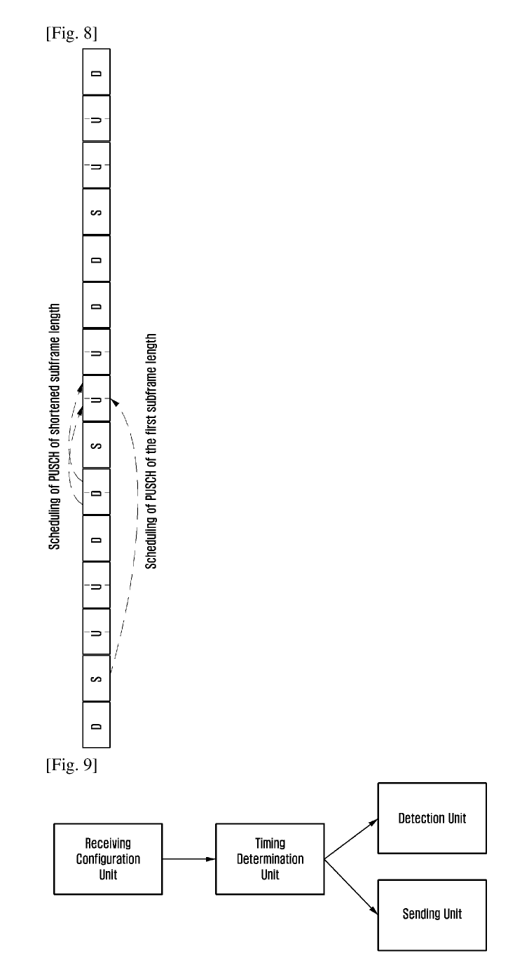

A method is that for a same UE, the UE can transmit a PUSCH of the first subframe length and a PUSCH of the shortened subframe length on a same subframe, or higher layer signaling configures whether a same UE can transmit a PUSCH of the first subframe length and a PUSCH of the shortened subframe length on a same subframe. If a PUSCH of the first subframe length and a PUSCH of the shortened subframe length are transmitted on a same subframe, they occupy different resource blocks. Since scheduling timing of a PUSCH of the first subframe length and scheduling timing of a PUSCH of the shortened subframe length are different, as shown in FIG. 8, a UL Grant for scheduling a PUSCH of the first subframe length of a same uplink subframe should be before a UL Grant for scheduling a PUSCH of the shortened subframe length. Thus, since when the PUSCH of the first subframe length is scheduled, all resources are scheduled, and there are no resources for scheduling the PUSCH of the shortened subframe length, therefore, when the PUSCH of the first subframe length is scheduled, some resources should be reserved for scheduling the PUSCH of the shortened subframe length. For a UE which has scheduled a PUSCH of the first subframe length, and on a same subframe, has scheduled a PUSCH of the shortened subframe length, and scheduled resources may overlay or totally same. In this case, a transmission of the PUSCH of the first subframe length may be stopped, but the PUSCH of the shortened subframe length may be transmitted, as the PUSCH of the shortened subframe length has a higher requirement for latency, it should be transmitted in first priority, but services of the PUSCH of the first subframe length stopped may be transmitted after services of the PUSCH of the shortened subframe length are transmitted.

Another method is that, for a same UE, the UE does not transmit a PUSCH of the first subframe length and a PUSCH of the shortened subframe length on a same subframe. If the UE receives scheduling of a PUSCH of the first subframe length and scheduling of a PUSCH of the shortened subframe length of a same uplink subframe, no matter whether resources scheduled are overlapped, one of the PUSCHs will be determined to be transmitted according to their priorities. For example, the transmission of the PUSCH of the first subframe length may be stopped, as there will be a peak-to-average ratio issue when two PUSCHs are transmitted on a same carrier. The transmission of the services of the PUSCH of the first subframe length stopped may be resumed after the transmission of the services of the PUSCH of the shortened subframe length is finished.

Another method is that for a same UE, if its power is not restricted, the UE may transmit a PUSCH of the first subframe length and a PUSCH of the shortened subframe length on a same subframe; and if power of the UE is limited, then power is allocated to the transmission of the PUSCH of the first subframe length and the PUSCH of the shortened subframe length according to their priorities. For example, power may be allocated to the PUSCH of the shortened subframe length first, and then power is allocated to the PUSCH of the first subframe length.

Another method is that since scheduling of a PUSCH of the first subframe length should before scheduling of a PUSCH of the shortened subframe length, and thus when the PUSCH of the first subframe length is scheduled, all the resources are scheduled, and there are no resources for scheduling of the PUSCH of the shortened subframe length. In this case, to schedule the PUSCH of the shortened subframe length and to prevent scheduling of the PUSCH of the first subframe length and scheduling of the PUSCH of the shortened subframe length from conflicting, whether the PUSCH of the first subframe length can be transmitted may be indicated through physical layer signaling in a public searching space or in a UE-specific searching space. Physical layer signaling may be transmitted on a downlink subframe of a UL Grant which schedules the PUSCH of the shortened subframe length, or may be transmitted on a downlink subframe after the downlink subframe of the UL Grant.

If the base station considers that the PUSCH of the first subframe length is more important, then the base station may schedule the PUSCH of the first subframe length without simultaneously scheduling the PUSCH of the shortened subframe length, which guarantees that the PUSCH of the first subframe length, the services of which are more important, can be transmitted in time.

In the following, a method for transmitting HARQ-ACK of a PDSCH of the first subframe length and HARQ-ACK of a PDSCH of the shortened subframe length on a same subframe will be described.

A method is that HARQ-ACK of the PDSCH of the first subframe length and HARQ-ACK of the PDSCH of the shortened subframe length are transmitted on different PUCCH channels respectively, and are allowed to be transmitted simultaneously. In this case, the downlink HARQ-ACK timing relationship does not need to be changed, and there is no loss in throughputs of downlink data. There will be the peak-to-average ratio issue when 2 PUCCHs are simultaneously transmitted on a same carrier.

Another method is that HARQ-ACK of the PDSCH of the first subframe length and HARQ-ACK of the PDSCH of the shortened subframe length cannot be transmitted simultaneously on a same subframe, but only one of them is transmitted. If one of HARQ-ACK of the PDSCH of the first subframe length and HARQ-ACK of the PDSCH of the shortened subframe length is present on a subframe, then HARQ-ACK of the PDSCH is transmitted, and if HARQ-ACK of the PDSCH of the first subframe length and HARQ-ACK of the PDSCH of the shortened subframe length, then one of them is determined to be transmitted according to their priorities, e.g., HARQ-ACK of the PDSCH of the shortened subframe length is transmitted. Or higher layer signaling configures whether HARQ-ACK of the PDSCH of the first subframe length and HARQ-ACK of the PDSCH of the shortened subframe length can be transmitted on a same subframe. In this case, there may be loss in throughputs of downlink data, but the peak-to-average ratio issue will not occur.

Another method is that HARQ-ACK of the PDSCH of the first subframe length and HARQ-ACK of the PDSCH of the shortened subframe length can be transmitted simultaneously on a subframe, but are only transmitted on a PUCCH channel. That is, HARQ-ACK of the PDSCH of the first subframe length and HARQ-ACK of the PDSCH of the shortened subframe length are coded together, and are transmitted on a PUCCH channel. This method may change a protocol a lot.

In the following, a method for transmitting a PUCCH for transmitting HARQ-ACK of a PDSCH of the first subframe length and a PUSCH of the shortened subframe length or a PUCCH for transmitting HARQ-ACK of a PDSCH of the shortened subframe length and a PUSCH of the first subframe length on a same subframe.

One method is that the PUCCH for transmitting HARQ-ACK of the PDSCH of the first subframe length and the PUSCH of the shortened subframe length can be transmitted simultaneously, and the PUCCH for transmitting HARQ-ACK of the PDSCH of the shortened subframe length and the PUSCH of the first subframe length can also be transmitted simultaneously, or higher layer signaling configures whether the PUCCH for transmitting HARQ-ACK of the PDSCH of the first subframe length and the PUSCH of the shortened subframe length can be transmitted simultaneously, or whether the PUCCH for transmitting HARQ-ACK the PDSCH of the shortened subframe length and the PUSCH of the first subframe length can be transmitted simultaneously. In this way, the timing relationship of downlink HARQ-ACK does not need to be modified, there is no loss in throughputs of downlink data, PUSCH will not be affected, but simultaneously transmitting 2 PUCCHs on a carrier may cause the peakto-average ratio issue.

Another method is that the PUCCH for transmitting HARQ-ACK of the PDSCH of the first subframe length and the PUSCH of the shortened subframe length cannot be transmitted simultaneously, or the PUCCH for transmitting HARQ-ACK of the PDSCH of the shortened subframe length and the PUSCH of the first subframe length cannot be transmitted simultaneously either. If only one of the PUCCH for transmitting HARQ-ACK of the PDSCH of the first subframe length and the PUSCH of the shortened subframe length is to be present on a subframe, then one of them is determined to be transmitted according to their priorities. A method for determining the priorities is that if the priority of the PUCCH for transmitting HARQ-ACK of the PDSCH of the first subframe length is higher than the priority of the PUSCH of the shortened subframe length, then the PUCCH for transmitting HARQ-ACK of the PDSCH of the first subframe length is transmitted, as the priority of control signaling is higher than the priority of data. Another method for determining the priorities is that the priority of the PUCCH for transmitting HARQ-ACK of the PDSCH of the first subframe length is lower than the priority of the PUSCH of the shortened subframe length, then the PUSCH of the shortened subframe length is transmitted, as services of the PUSCH of the shortened subframe length have a higher requirement for latency, and thus the priority of the PUSCH of the shortened subframe length which has a higher requirement for latency is higher than the priority of the PUCCH for transmitting HARQ-ACK of the PDSCH of the first subframe length. If only one of the PUCCH for transmitting HARQ-ACK of the PDSCH of the shortened subframe length and the PUSCH of the first subframe length is to be present on a subframe, then one of them is determined to be transmitted according to their priorities. A method for determining the priorities is that the priority of the PUCCH for transmitting HARQ-ACK of the PDSCH of the shortened subframe length is higher than the priority of the PUSCH of the first subframe length, then the PUCCH for transmitting HARQ-ACK of the PDSCH of the shortened subframe length is transmitted, as the PUCCH for transmitting HARQ-ACK of the PDSCH of the shortened subframe length is control signaling, and the PDSCH of the shortened subframe length has a higher requirement for latency than the PUSCH of the first subframe length.

Another method is that the PUCCH for transmitting HARQ-ACK of the PDSCH of the first subframe length and the PUSCH of the shortened subframe length can be transmitted simultaneously, and the PUCCH for transmitting HARQ-ACK of the PDSCH of the shortened subframe length and the PUSCH of the first subframe length can be transmitted simultaneously too, but are transmitted on a PUSCH channel. That is, HARQ-ACK of the PDSCH of the first subframe length is transmitted on a PUSCH of the shortened subframe length, and HARQ-ACK of the PDSCH of the shortened subframe length is transmitted on a PUSCH of the first subframe length. This method may change a lot to a protocol.

In the following, a method for transmitting a PUSCH of the first subframe length, a PUSCH of a shortened subframe length, a PUCCH for transmitting HARQ-ACK of a PDSCH of the first subframe length, and a PUCCH for transmitting HARQ-ACK of a PDSCH of the shortened subframe length on a same subframe will be described.

A method is that whether the PUCCH for transmitting HARQ-ACK of the PDSCH of the first subframe length and the PUSCH of the shortened subframe length can be transmitted simultaneously is configured by higher layer signaling, and the PUCCH for transmitting HARQ-ACK of the PDSCH of the shortened subframe length and the PUSCH of the shortened subframe length can be transmitted simultaneously is configured by higher layer signaling. They are configured by higher layer signaling separately. That is, if higher signaling configures that the PUCCH of the first subframe length and the PUSCH of the first subframe length can be transmitted simultaneously, then the PUCCH of the first subframe length and the PUSCH of the first subframe length are transmitted respectively, and if higher layer signaling configures that the PUCCH of the first subframe length and the PUSCH of the first subframe length cannot be transmitted simultaneously, then information of the PUCCH is transmitted in the PUSCH; and if higher layer signaling configures that the PUCCH of the shortened subframe length and the PUSCH of the shortened subframe length can be transmitted simultaneously, then the PUCCH of the shortened subframe length and the PUSCH of the shortened subframe length are transmitted respectively, and if higher layer signaling configures that the PUCCH of the shortened subframe length and the PUSCH of the shortened subframe length cannot be transmitted simultaneously, then information of the PUCCH is transmitted in the PUSCH of the shortened subframe length. Or higher layer signaling configures whether the PUCCH for transmitting HARQ-ACK of the PDSCH of the first subframe length and the PUSCH of the first subframe length can be transmitted simultaneously, and whether the PUCCH for transmitting HARQ-ACK of the PDSCH of the shortened subframe length and the PUSCH of the shortened subframe length can be transmitted simultaneously. That is higher layer signaling configures that the PUCCH of the first subframe length and the PUSCH of the first subframe length can be transmitted simultaneously, and the PUCCH of the shortened subframe length and the PUSCH of the shortened subframe length can be transmitted simultaneously, and the PUCCH of the first subframe length and the PUSCH of the first subframe length can be transmitted respectively, and the PUCCH of the shortened subframe length and the PUSCH of the shortened subframe length are transmitted respectively; if higher layer signaling configures that the PUCCH of the first subframe length and the PUSCH of the first subframe length cannot be transmitted simultaneously, and that the PUCCH of the shortened subframe length and the PUSCH of the shortened subframe length cannot be transmitted simultaneously, then information of the PUCCH of the first subframe length is transmitted in the PUSCH of the first subframe length, and information of the PUCCH of the shortened subframe length is transmitted in the PUSCH of the shortened subframe length. If higher layer signaling configures that the PUCCH of the first subframe length and the PUSCH of the first subframe length cannot be transmitted simultaneously, if power is not restricted, and resources of the PUSCH of the first subframe length and resources of the PUSCH of the shortened subframe length do not overlap, then information of the PUCCH of the first subframe length is transmitted in the PUSCH of the first subframe length; if because the resources of the PUSCH of the first subframe and the resources of the PUSCH of the shortened subframe length overlap, the PUCCH of the first subframe length and the PUSCH of the shortened subframe length cannot be transmitted, information of the PUCCH of the first subframe length is transmitted in the PUCCH, and the PUSCH of the first subframe length will not be transmitted, or when power is restricted and is not enough to transmit the PUSCH of the first subframe length which carries information of the PUCCH, information of the PUCCH of the first subframe length is transmitted in the PUCCH of the first subframe length, and the PUSCH of the first subframe length will not be transmitted.

Another method is that higher layer signaling configures that the PUCCH for transmitting HARQ-ACK of the PDSCH of the first subframe length and the PUSCH of the first subframe length cannot be transmitted, and that the PUCCH for transmitting HARQ-ACK of the PDSCH of the shortened subframe length and the PUSCH of the shortened subframe length cannot be transmitted simultaneously. That is if the PUCCH for transmitting HARQ-ACK of the PDSCH of the first subframe length and the PUSCH of the first subframe length need to be transmitted on a same subframe, then the PUCCH for transmitting HARQ-ACK of the PDSCH of the first subframe length is stopped, and HARQ-ACK of the PDSCH of the first subframe length is transmitted in the PUSCH of the first subframe length; and if the PUCCH for transmitting HARQ-ACK of the PDSCH of the shortened subframe and the PUSCH of the shortened subframe length need to be transmitted on a same subframe, then the transmission of the PUCCH for transmitting HARQ-ACK of the PDSCH of the shortened subframe length is stopped, and HARQ-ACK of the PDSCH of the shortened subframe length is transmitted in the PUSCH of the shortened subframe length.

The foregoing are implementations of the methods for transmitting PUSCHs of the present disclosure. The present disclosure further provides a user equipment for transmitting PUSCHs, which can be used to implement the foregoing methods. FIG. 9 is a schematic diagram of a basic structure of the user equipment provided according to the present disclosure. As shown in FIG. 9, the user equipment includes: a receiving configuration unit, a timing determination unit, a detection unit, and a sending unit.

The receiving unit is configured to receive configuration information of a base station, and configuration information is configured to configure an operation mode of the UE working on a shortened subframe. The timing determination unit is configured to determine a timing relationship from a UL Grant to a PUSCH, a timing relationship from a PHICH to a PUSCH, and a timing relationship from a PUSCH to a PHICH; in which, the timing relationships are used for transmission of PUSCHs on shortened uplink subframes. The detection unit is configured to detect a UL Grant and/or a PHICH according to a determined timing relationship. The sending unit is configured to send PUSCH data on a shortened uplink subframe according to a determined timing relationship.

What is described in the foregoing are only embodiments of the present disclosure, and should not be construed as limitations to the present disclosure. Any changes, equivalent replacements, modifications made without departing from the scope and spirit of the present disclosure are intended to be included within the protecting scope of the present disclosure.

1. A method of user equipment (UE) for transmitting physical uplink shared channels (PUSCHs), the method comprising:
receiving, configuration information from a base station, wherein the configuration information is to configure an operation mode of the UE to operate on shortened subframes;
determining, a timing relationship from uplink grant (UL Grant) to PUSCH, a timing relationship from physical hybrid automatic retransmission request (ARQ) indicator channel (PHICH) to PUSCH, and a timing relationship from PUSCH to PHICH, and detecting a UL grant and/or a PHICH according to the determined timing relationships;
wherein the timing relationships are used for transmission of PUSCHs on shortened subframes; and
transmitting, based on the detected UL Grant and/or the PHICH, data of a PUSCH of a shortened uplink subframe according to the timing relationships determined by the UE.

2. The method of claim 1, wherein latency from the UL Grant/PHICH to the PUSCH is not smaller than preset s1 milliseconds, and latency from the PUSCH to a PHICH is not smaller than preset s2 milliseconds.

3. The method of claim 2, wherein s1=2, or s2=2.

4. The method of claim 1, wherein the timing relationship from UL Grant/PHICH to PUSCH is that the UL Grant/PHICH received on a shortened downlink subframe n is used to schedule the PUSCH on an uplink subframe n+k, where values of k are shown in Table 1, and “/” indicates “or”,
TABLE 1

| Config- | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | |
|---|---|---|---|---|---|---|---|---|---|
| 0 | 4 | 4 | 4 | 4 | 4 | 4 | 4 | 4 | |
| 1 | 4 | 4 | 4 | 4 | 4 | 4 | 4 | 4 | |
| 2 | 4 | 4 | | | 4 | 4 | | | |
| 3 | 4 | 4 | 4 | 4 | | | | | |
| 4 | 4 | 4 | 4 | 4 | | | | | |
| 5 | 4 | 4 | | | | | | | |
| 6 | 4 | 4 | 4 | 4 | 4 | 4 | 4 | 4 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 2,
TABLE 2

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | |
|---|---|---|---|---|---|---|---|---|
| 0 | 6 | 6 | 6 | 6 | 6 | 6 | 6 | 6 |
| 1 | 6 | 6 | 6 | 6 | 6 | 6 | 6 | 6 |
| 2 | 6 | 6 | | | 6 | 6 | | |
| 3 | 16 | 16 | 16 | 16 | | | | |
| 4 | 16 | 16 | 16 | 16 | | | | |
| 5 | 16 | 16 | | | | | | |
| 6 | 6 | 6 | 6 | 6 | 6 | 6 | 6 | 6 |

5. The method of claim 1, wherein the timing relationship from UL Grant/PHICH to PUSCH is that the UL Grant/PHICH received on a shortened downlink subframe n is used to schedule the PUSCH on a shortened uplink subframe n+k, where values of k are shown in Table 3,
TABLE 3

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | |
|---|---|---|---|---|---|---|---|
| 0 | 4 | 4 | 4, 5 | 4 | 4 | 4, 5 | |
| 1 | 4 | 4 | 4, 5 | 4 | 4 | 4, 5 | |
| 2 | 4 | 4 | | 4 | 4 | | |
| 3 | 4 | 4 | 4, 5 | | | | |
| 4 | 4 | 4 | 4, 5 | | | | |
| 5 | 4 | 4 | | | | | |
| 6 | 4 | 4 | 4, 5 | 4 | 4 | 4, 5 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 4,
TABLE 4

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | |
|---|---|---|---|---|---|---|---|---|---|
| 0 | 6 | 6 | 6 | 5 | 6 | 6 | 6 | 5 | |
| 1 | 6 | 6 | 6 | 5 | 6 | 6 | 6 | 5 | |
| 2 | 6 | 6 | | | 6 | 6 | | | |
| 3 | 16 | 16 | 16 | 15 | | | | | |
| 4 | 16 | 16 | 16 | 15 | | | | | |
| 5 | 16 | 16 | | | | | | | |
| 6 | 6 | 6 | 6 | 5 | 6 | 6 | 6 | 5 | ; |

and
for shortened downlink subframes 0, 1, 10 and 11 in TDD uplink and downlink configurations 0, 1, 2, and 6 and shortened downlink subframes 0 and 1 in TDD uplink and downlink configurations 3, 4, and 5, only one PHICH source set is configured; and for shortened downlink subframes 2 and 12 in the TDD uplink and downlink configurations 0, 1, and 6 and shortened downlink subframe 2 in the TDD uplink and downlink configurations 3 and 4, two PHICH resource sets are configured.

6. The method of claim 1, wherein the timing relationship from UL Grant/PHICH to PUSCH is that the UL Grant/PHICH received on a shortened downlink subframe n is configured to schedule the PUSCH on a shortened uplink subframe n+k, where values of k are shown in Table 5,
TABLE 5

| Config- | Shortened Downlink Subframe n for receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | | | | |
|---|---|---|---|---|---|---|---|---|---|---|---|---|
| 0 | 4 | 4 | 4 | 4 | | | 4 | 4 | 4 | 4 | | |
| 1 | 6 | 6 | | | 6 | 6 | 6 | 6 | | | 6 | 6 |
| 2 | 4 | 4 | | | | | 4 | 4 | | | | |
| 3 | 6 | 6 | | | | | | | | | 6 | 6 |
| 4 | 6 | 6 | | | | | | | | | 6 | 6 |
| 5 | 4 | 4 | | | | | | | | | | |
| 6 | 4 | 4 | 4 | 4 | | | 4 | 4 | 4 | 4 | | ; |

the timing relation from PUSCH to PHICH is that the PHICH corresponding to the PUSCH transmitted on a shortened uplink subframe n is transmitted on a shortened downlink subframe n+k′, where values of k′ are shown in Table 6,
TABLE 6

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | |
|---|---|---|---|---|---|---|---|---|---|
| 0 | 6 | 6 | 6 | 6 | 6 | 6 | 6 | 6 | |
| 1 | 6 | 6 | 6 | 6 | 6 | 6 | 6 | 6 | |
| 2 | 6 | 6 | | | 6 | 6 | | | |
| 0 | 6 | 6 | 6 | 6 | 6 | 6 | 6 | 6 | |
| 4 | 16 | 16 | 16 | 16 | | | | | |
| 5 | 16 | 16 | | | | | | | |
| 6 | 6 | 6 | 6 | 6 | 6 | 6 | 6 | 6 | . |

7. The method of claim 1, wherein the timing relationship from UL Grant/PHICH to PUSCH is that the UL Grant/PHICH received on a shortened downlink subframe n is used to schedule the PUSCH on a shortened uplink subframe n+k, where values of k are shown in Table 7,
TABLE 7

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | | |
|---|---|---|---|---|---|---|---|---|---|---|
| 0 | 4 | 4 | 4, 5 | | | 4 | 4 | 4, 5 | | |
| 1 | 6 | 6 | | 6 | 6 | 6 | 6 | | 6 | 6 |
| 2 | 4 | 4 | | | | 4 | 4 | | | |
| 3 | 6 | 6 | | | | | | | 6 | 6 |
| 4 | 6 | 6 | | | | | | | 6 | 6 |
| 5 | 4 | 4 | | | | | | | | |
| 6 | 4 | 4 | 4, 5 | | | 4 | 4 | 4, 5 | | ; |

and
the timing relationship from PUSCH to PHICH is that the PHICH corresponding to the PUSCH transmitted on a shortened uplink subframe n is transmitted on a shortened downlink subframe n+k′, where values of k′ are as shown in Table 8,
TABLE 8

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | |
|---|---|---|---|---|---|---|---|---|---|
| 0 | 6 | 6 | 6 | 5 | 6 | 6 | 6 | 5 | |
| 1 | 4 | 4 | 4 | 4 | 4 | 4 | 4 | 4 | |
| 2 | 6 | 6 | | | 6 | 6 | | | |
| 3 | 14 | 14 | 14 | 14 | | | | | |
| 4 | 14 | 14 | 14 | 14 | | | | | |
| 5 | 16 | 16 | | | | | | | |
| 6 | 6 | 6 | 6 | 5 | 6 | 6 | 6 | 5 | ; |

for shortened downlink subframes 2 and 12 in TDD uplink and downlink configurations 0 and 6, two PHICH resource sets are configured, and for shortened downlink subframes 0, 1, 10, and 11 in the TDD uplink and downlink configurations 0 and 6 and shortened downlink subframes on other TDD uplink and downlink configurations, one PHICH resource set is configured.

8. The method of claim 1, wherein for the TDD uplink and downlink configuration 0, the timing relationship from UL Grant/PHICH to PUSCH is that the UL Grant/PHICH received on a shortened downlink subframe n is configured to schedule the PUSCH on a shortened uplink subframe n+k, where values of k are shown in Table 9,
TABLE 9

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | |
|---|---|---|---|---|---|---|---|---|
| 0 | 4, 5 | 5, 6 | 6 | 4, 5 | 5, 6 | 6 | 6 | ; |

the timing relationship from PUSCH to PHICH is that the PHICH corresponding to the PUSCH transmitted on a shortened downlink subframe n is transmitted on a shortened downlink subframe n+k′, where values of k′ are shown in Table 10,
TABLE 10

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | | | | |
|---|---|---|---|---|---|---|---|---|---|---|---|---|
| 0 | 6 | 5 | 5 | 4 | 4 | 4 | 6 | 5 | 5 | 4 | 4 | 4; |

shortened downlink subframes 0, 1, 10, and 11 in a TDD uplink downlink configuration 0 is configured with two PHICH resource sets, and shortened downlink subframes 2, 3, 12, and 13 in the TDD uplink and downlink configuration 0 are configured with one PHICH resource set; and/or,
for a TDD uplink and downlink configuration 6, the timing relationship from UL Grant/PHICH to PUSCH is that the UL Grant/PHICH received on a shortened downlink subframe n is configured to schedule the PUSCH on a shortened uplink subframe n+k, where values of k are shown in Table 11,
TABLE 11

| Config- | Shortened Downlink Subframe n for Receiving a UL Grant/PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | |
|---|---|---|---|---|---|---|---|---|
| 6 | 4, 5 | 5, 6 | 6 | 6 | 4 | 4 | 4 | 4 |

the timing relationship from PUSCH to PHICH is that the PHICH corresponding to the PUSCH transmitted on a shortened uplink subframe n is transmitted on a shortened downlink subframe n+k′, where values of k′ are shown in Table 12,
TABLE 12

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | | | |
|---|---|---|---|---|---|---|---|---|---|---|---|
| 6 | 6 | 5 | 5 | 4 | 4 | 4 | 6 | 6 | 6 | 6 | , |

shortened downlink subframes 0, 1, 2, 3, 12, and 13 in the TDD uplink and downlink configuration 6 are configured with one PHICH resource set, and shortened downlink subframes 10 and 11 in the TDD uplink and downlink configuration 6 are configured with two PHICH resource sets; or for the TDD uplink and downlink configuration 6, the timing relationship from UL Grant/PHICH to PUSCH is that the UL Grant/PHICH received on a shortened downlink subframe n is used to schedule the PUSCH on a shortened uplink subframe n+k, where values of k are shown in Table 13,
TABLE 13

| Config- | Shortened Downlink Subframe n for Receiving a UL Grant PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | |
|---|---|---|---|---|---|---|---|---|
| 6 | 4, 5 | 5, 6 | 6 | 6 | 4 | 4 | 4, 5 | , |

the timing relationship from PUSCH to PHICH is that: the PHICH corresponding to the PUSCH transmitted on a shortened uplink subframe n is transmitted on a shortened downlink subframe n+k′, where values of k′ are shown in Table 14,
TABLE 14

| Config- | Shortened uplink subframe n for PUSCH transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | | | |
|---|---|---|---|---|---|---|---|---|---|---|---|
| 6 | 6 | 5 | 5 | 4 | 4 | 4 | 6 | 6 | 6 | 5 | , |

the shortened downlink subframe 0, 1, 12, and 13 in TDD uplink and downlink configuration 6 are configured with one PHICH resource set, and the shortened downlink subframes 2, 10 and 11 in the TDD uplink and downlink configuration 6 are configured with two PHICH resource sets; and/or
for TDD uplink and downlink configuration 3, the timing relationship from UL Grant/PHICH to PUSCH is that the UL Grant/PHICH received on a shortened downlink subframe n is used to schedule the PUSCH on the shortened uplink subframe n+k, where values of k are shown in Table 15,
TABLE 15

| Config- | Shortened Downlink Subframe n for Receiving a UL Grant PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | |
|---|---|---|---|---|---|
| 3 | 4, 5 | 5, 6 | 6 | 6 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 16,
TABLE 16

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | |
|---|---|---|---|---|---|---|---|
| 3 | 16 | 15 | 15 | 14 | 14 | 14 | ; |

the shortened downlink subframes 0 and 1 in the TDD uplink and downlink configuration 3 are configured with two PHICH resources sets, and shortened downlink subframes 2 and 3 in the TDD uplink and downlink configuration 3 are configured with one PHICH resource set.

9. The method of claim 1, wherein for the TDD uplink downlink configuration 3, the timing relationship from UL Grant/PHICH to PUSCH is that the UL Grant/PHICH received on a shortened downlink subframe n is used to schedule the PUSCH on a shortened uplink subframe n+k, where values of k are shown in Table 17,
TABLE 17

| Config- | Shortened Downlink Subframe n for Receiving a UL Grant PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | |
|---|---|---|---|---|---|---|
| 3 | 6 | 6 | 6 | 6 | 6 | 6; |

the timing relationship from PUSCH to PHICH is that the PHICH corresponding to the PUSCH transmitted on a shortened uplink subframe n is transmitted on a shortened downlink subframe n+k′, where values of k′ are shown in Table 18,
TABLE 18

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | |
|---|---|---|---|---|---|---|---|
| 3 | 14 | 14 | 14 | 14 | 14 | 14 | ; |

Or,
for the TDD uplink and downlink configuration 3, the timing relationship from UL Grant/PHICH to PUSCH is that the UL Grant/PHICH received on a shortened downlink subframe n is used to schedule the PUSCH on a shortened uplink subframe n+k, where values of k are shown in Table 19,
TABLE 19

| Config- | Shortened Downlink Subframe tor Receiving a UL Grant PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | |
|---|---|---|---|---|---|---|
| 3 | 7 | 7 | 7 | 7 | 7 | 7; |

the timing relationship from PUSCH to PHICH is that the PHICH corresponding to the PUSCH transmitted on a shortened uplink subframe n is transmitted on a shortened downlink subframe n+k′, where values of k′ are shown in Table 20,
TABLE 20

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | |
|---|---|---|---|---|---|---|---|
| 3 | 13 | 13 | 13 | 13 | 13 | 13 | . |

10. The method of claim 2, where s1=s2=2.5.

11. The method of claim 1, wherein the timing relationship from UL Grant/PHICH to PUSCH is that the UL Grant/PHICH received on a shortened downlink subframe n is used to schedule the PUSCH on a shortened uplink subframe n+k, where values of k are shown in Table 21,
TABLE 21

| Config- | Shortened Downlink Subframe n for Receiving a UL Grant PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | |
|---|---|---|---|---|---|---|---|
| 0 | 5 | 5 | 5 | 5 | 5 | 5 | |
| 1 | 5 | 5 | 5 | 5 | 5 | 5 | |
| 2 | 5 | | | 5 | | | |
| 3 | 5 | 5 | 5 | | | | |
| 4 | 5 | 5 | 5 | | | | |
| 5 | 5 | | | | | | |
| 6 | 5 | 5 | 5 | 5 | 5 | 5 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 22,
TABLE 22

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | |
|---|---|---|---|---|---|---|---|
| 0 | 5 | 5 | 5 | 5 | 5 | 5 | |
| 1 | 5 | 5 | 5 | 5 | 5 | 5 | |
| 2 | 5 | | | 5 | | | |
| 3 | 15 | 15 | 15 | | | | |
| 4 | 15 | 15 | 15 | | | | |
| 5 | 15 | | | | | | |
| 6 | 5 | 5 | 5 | 5 | 5 | 5 | . |

12. The method of claim 1, wherein the timing relationship from UL Grant/PHICH to PUSCH is that the UL Grant/PHICH received on a shortened downlink subframe n is used to schedule the PUSCH on a uplink subframe n+k, where values of k are shown in Table 23,
TABLE 23

| Config- | Shortened Downlink Subframe n for receiving a UL Grant PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | |
|---|---|---|---|---|---|---|---|---|
| 0 | 5 | 5 | 5 | | 5 | 5 | 5 | |
| 1 | 5 | 5 | 5 | 5 | 5 | 5 | 5 | 5 |
| 2 | 5 | | | 5 | 5 | | | 5 |
| 3 | 5 | 5 | 5 | | | | | 5 |
| 4 | 5 | 5 | 5 | | | | | 5 |
| 5 | 5 | | | | | | | 5 |
| 6 | 5 | 5 | 5 | | 5 | 5 | 5 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 24,
TABLE 24

| Config- | Shortened Uplink Subframe n for PUSCH transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | |
|---|---|---|---|---|---|---|---|---|---|
| 0 | | 5 | 5 | 5 | | 5 | 5 | 5 | |
| 1 | 5 | 5 | 5 | 5 | 5 | 5 | 5 | 5 | |
| 2 | 5 | 5 | | | 5 | 5 | | | |
| 3 | 15 | 15 | 15 | 15 | | | | | |
| 4 | 15 | 15 | 15 | 15 | | | | | |
| 5 | 15 | 15 | | | | | | | |
| 6 | | 5 | 5 | 5 | | 5 | 5 | 5 | . |

13. The method of claim 1, wherein for TDD uplink and downlink configurations 0 and 6, the timing relationship from UL Grant/PHICH to PUSCH is that the UL Grant/PHICH received on a shortened downlink subframe n is used to schedule a PUSCH on a shortened uplink subframe n+k, where values of k are shown in Table 25,
TABLE 25

| Config- | Shortened Downlink Subframe n for Receiving a UL Grant PHICH | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | |
|---|---|---|---|---|---|---|---|---|---|
| 0 | 5 | 5 | 5 | 5 | 5 | 5 | 5 | 5 | |
| 6 | 5 | 5 | 5 | 5 | 5 | 5 | 5 | 5 | ; |

the timing relationship from PUSCH to PHICH is that the PHICH corresponding to the PUSCH transmitted on a shortened uplink subframe n is transmitted on a shortened downlink subframe n+k′, where values of k′ are shown in Table 26,
TABLE 26

| Config- | Shortened Uplink Subframe n for PUSCH Transmission | | | | | | | | | | | | | | | | | | | |
|---|---|---|---|---|---|---|---|---|---|---|---|---|---|---|---|---|---|---|---|---|
| uration | 0 | 1 | 2 | 3 | 4 | 5 | 6 | 7 | 8 | 9 | 10 | 11 | 12 | 13 | 14 | 15 | 16 | 17 | 18 | 19 |
| | | | | | | | | | |
|---|---|---|---|---|---|---|---|---|---|
| 0 | 5 | 5 | 5 | 5 | 5 | 5 | 5 | 5 | |
| 6 | 5 | 5 | 5 | 5 | 5 | 5 | 5 | 5 | ; |

for shortened downlink subframes 0, 1, 10 and 11 in the TDD uplink and downlink configuration 0, two PHICH resource sets are configured, and for shortened downlink subframes 2, 3, 12, and 13, one PHICH resource set is configured.

14. A user equipment (UE) for transmitting physical uplink shared channels (PUSCHs), the UE comprising:
a transceiver configured to transmit and receive a signal; and
a controller configured to receive configuration information from a base station, and the configuration information is used to configure an operation mode of the UE to operate on shortened subframes, determine a timing relationship from UL Grant to PUSCH, a timing relationship from PHICH to PUSCH, and a timing relationship from PUSCH to PHICH, wherein the timing relationships are used for transmission of PUSCHs on shortened uplink subframes, detect a UL Grant and/or a PHICH according to the determined timing relationships and transmit data of a PUSCH of a shortened uplink subframe based on the detected UL Grant and/or PHICH according to the timing relationships determined.
